(19) United States
(12) Patent Application Publication
(10) Pub. No.: US 2021/0286283 A1
(43) Pub. Date: Sep. 16, 2021

(54) TONER

(71) Applicant: CANON KABUSHIKI KAISHA, Tokyo (JP)

(72) Inventors: Tomoya Nagaoka, Tokyo (JP); Yasuhiro Hashimoto, Shizuoka (JP); Koji Nishikawa, Shizuoka (JP); Yuujirou Nagashima, Shizuoka (JP)

(21) Appl. No.: 17/193,079

(22) Filed: Mar. 5, 2021

(30) Foreign Application Priority Data
Mar. 16, 2020 (JP) 2020-045835

(51) Int. Cl. G03G 9/097; G03G 9/093; G03G 9/08; C08G 77/04

(52) U.S. Cl. CPC G03G 9/09775; G03G 9/09364; C08G 77/04; G03G 9/0819; G03G 9/09335

(57) ABSTRACT

A toner comprising a toner particle and an external additive on a surface of the toner particle, wherein the toner particle comprises a core particle containing a binder resin and a shell layer on a surface of the core particle, the shell layer comprises a compound containing nitrogen atoms, the external additive comprises an organosilicon polymer particle, and a difference between the work function Wa of the organosilicon polymer particle and the work function Wb of the toner particle satisfies the following formula (A):

0.00 eV<Wa−Wb≤0.75 eV (A)

### BACKGROUND OF THE INVENTION

### Field of the Invention

The present disclosures relate to a toner for use in image forming methods such as electrophotography.

### Description of the Related Art

Longer lives and greater energy efficiency are being required from electrophotographic image forming apparatus, and further improvements in toner performance are needed to address these demands. From the standpoint of extending device lives in particular, toners with greater quality stability or in other words long-term durability are required. From the standpoint of energy efficiency, greater low-temperature fixability is required.

As use environments become more diverse, moreover, there is increased demand for toners that can maintain a certain level of image quality in any use environment (reducing the environmental dependence of image quality).

In conventional designs, the viscosity of the toner core has been reduced in an effort to improve low-temperature fixability. However, because simply lowering the viscosity of the toner core can have various adverse effects on durability and the like, durability has been maintained by providing a resin shell layer on the surface of the toner core and using spacer particles as external additives. The environmental dependence of image quality has also been reduced by controlling the properties of the external additives and the shell layer on the surface of the toner core.

WO 2019/065730 proposes improving toner aggregation and durability in a supply cartridge by externally adding a lubricant particle to a toner particle and controlling the charging polarity of the external additive.

Japanese Patent Application Publication No. 2017-21262 proposes that faulty cleaning and member contamination can be resolved by externally adding a resin particle to a toner particle.

Japanese Patent Application Publication No. 2018-136374 proposes improving durability by controlling the difference in work function between a shell layer on the toner particle surface and silica used as an external additive.

Some effects on toner aggregation, cleaning properties and durability have been confirmed with these technologies.

### SUMMARY OF THE INVENTION

However, there is room for further research into toner cores with improved low-temperature fixability in order to achieve long-term durability while greatly reducing the environmental dependence of image quality. The present disclosure provides a toner that resolves these issues. Specifically, it provides a toner whereby long-term durability can be achieved while suppressing the environmental dependence of image quality with a toner having improved low-temperature fixability.

A toner comprising a toner particle and an external additive on a surface of the toner particle, wherein

the toner particle comprises
a core particle containing a binder resin and
a shell layer on a surface of the core particle,

the shell layer comprises a compound containing nitrogen atoms,

the external additive comprises an organosilicon polymer particle, and

a difference between the work function Wa of the organosilicon polymer particle and the work function Wb of the toner particle satisfies the following formula (A):

0.00 eV<Wa−Wb≤0.75 eV (A)

The present disclosure can provide a toner whereby long-term durability can be achieved while suppressing the environmental dependence of image quality with a toner having improved low-temperature fixability.

Further features of the present invention will become apparent from the following description of exemplary embodiments with reference to the attached drawings.

### BRIEF DESCRIPTION OF THE DRAWINGS

The FIGURE shows one example of a work function measurement curve.

### DESCRIPTION OF THE EMBODIMENTS

In the present disclosure, the notations “from XX to YY” and “XX to YY” representing a numerical range denote, unless otherwise stated, a numerical value range that includes the lower limit and the upper limit thereof, as endpoints.

In a case where numerical value ranges are described in stages, the upper limits and the lower limits of the respective numerical value ranges can be combined arbitrarily.

The “monomer unit” refers to the reacted form of the monomer substance in the polymer.

As discussed above, it is hard to improve both the long-term durability and environmental dependence of image quality simply by providing a resin shell layer on the surface of the toner core particle and using a spacer particle as an external additive.

As a result of further research, the inventors considered that long-term durability declines because the spacer particles become embedded in the toner core particles due to stress during long-term use. It was also thought that the reason why the image quality varies according to the printing environment is that the chargeability of the toner varies according to the use environment, or in other words that the chargeability of the shell layer on the toner particle surface varies according to the environment.

Therefore, the inventors thought that the design of the toner surface layer is important for improving both the long-term durability and environmental dependence of image quality while maintaining low-temperature fixability.

Specifically, it was discovered that the problems described above could be resolved with a toner including

a toner particle and an external additive on the surface of the toner particle, wherein

the toner particle has a core particle containing a binder resin and a shell layer on the surface of the core particle,

the shell layer contains a compound containing nitrogen atoms,

the external additive contains an organosilicon polymer particle, and

the difference between the work function Wa of the organosilicon polymer particle and the work function Wb of the toner particle is described by the following formula (A):

0.00 eV<Wa−Wb≤0.75 eV (A)

This toner contains an organosilicon polymer particle as an external additive. The organosilicon polymer particle has elasticity. Even if the toner is under continuous load from the developing device or the like during long-term use, the organosilicon polymer particle deforms elastically to absorb the load. When the load is released, the organosilicon polymer particle returns to its original shape. The organosilicon polymer particle is thus less likely to become embedded in the toner particle. As a result, the organosilicon polymer particle has the effect of improving long-term durability when used as a spacer particle.

If a spacer particle is an inorganic fine particle, the inorganic fine particle may gradually become more and more embedded in the toner particle as it continues to receive load during long-term use, and long-term durability may not be maintained. This is thought to be because the inorganic fine particle cannot deform elastically and cannot absorb load.

If a spacer particle is a resin fine particle, the resin fine particle can absorb load because it has elasticity, but under continuous load during long-term use the resin fine particle itself may gradually collapse due to progressive plastic deformation, and long-term durability may not be maintained. Fogging may also occur because the resin fine particle has insufficient chargeability.

The shell layer contains a compound containing nitrogen atoms. Because a compound containing nitrogen atoms is contained in the shell layer, charge transfer occurs smoothly between this compound and the organosilicon polymer particle, resulting in a good positive-charge toner. Long-term durability can also be maintained even with a toner particle having improved low-temperature fixability. It is also easier to control the work function difference between the organosilicon polymer particle and the toner particle.

The difference (Wa−Wb) between the work function Wa of the organosilicon polymer particle and the work function Wb of the shell layer is described by the following formula (A):

0.00 eV<Wa−Wb≤0.75 eV (A)

Wa−Wb is greater than 0.00 eV, and preferably at least 0.10 eV, or more preferably at least 0.20 eV.

If Wa−Wb is within this range, charge transfer occurs smoothly between the toner particle and the organosilicon polymer particle, and the toner charge increases soon after the start of printing. The image quality at the start of printing in high-temperature high-humidity environments can be improved as a result.

The toner particle and the organosilicon polymer particle also have opposite polarities as a result of charge transfer, strengthening the adhesive force between the toner particle and the organosilicon polymer particle. Long-term durability can be further improved as a result.

When there is no difference between Wa and Wb, charge does not transfer easily and chargeability is reduced. The image quality at the start of printing is therefore reduced in high-temperature high-humidity environments. The adhesive force between the toner particle and the organosilicon polymer particle is also weaker, detracting from long-term durability.

Wa−Wb is also not more than 0.75 eV, or preferably not more than 0.73 eV, or still more preferably not more than 0.60 eV, or yet more preferably not more than 0.50 eV.

If Wa−Wb is within this range, charge transfer between the toner particle and the organosilicon polymer particle can be maintained at or below a certain level, and toner aggregation due to charge-up can be suppressed. It is thus possible to improve image quality in low-temperature low-humidity environments. If Wa−Wb is outside this range, toner aggregation due to charge-up is more likely, and vertical streaks are likely to occur in low-temperature low-humidity environments.

In transmission electron microscope (TEM) observation, the coverage of the core particle by the shell layer is preferably at least 30%, or more preferably at least 50%. There is no particular upper limit, but preferably it is not more than 100%, or more preferably not more than 90%.

If the coverage is within this range, the toner surface layer is likely to be uniform, chargeability and image density are improved, and fogging can be easily controlled. It is also easy to further improve long-term durability. The coverage of the core particle by the shell layer can be controlled by changing the added amount of the shell agent and the manufacturing conditions during shell formation.

The average thickness of the shell layer is preferably from 1 nm to 250 nm, or more preferably from 10 nm to 200 nm. Within this range, it is easy to obtain a good balance of long-term durability and low-temperature fixability. The shell layer thickness can be controlled by changing the added amount of the shell agent and the manufacturing conditions during shell formation.

The number average particle diameter of the primary particles of the organosilicon polymer particle is preferably from 30 nm to 500 nm, or more preferably from 50 nm to 200 nm.

If the number average particle diameter of the primary particles is within this range, low-temperature fixability and long-term durability can be easily improved. If the number average particle diameter of the primary particles is at least 30 nm, they can easily function as spacer particles to improve long-term durability.

If the number average particle diameter of the primary particles is not more than 500 nm, cohesion between toner particles and between the toner and the paper during fixing and melting is improved, resulting in good low-temperature fixability. During long-term use, the organosilicon polymer particles are unlikely to become detached from the toner particles and can maintain their function as spacer particles, resulting in improved long-term durability.

The number average particle diameter of the primary particles of the organosilicon polymer particle can be controlled by changing the organosilicon polymer particle manufacturing conditions.

The content of the organosilicon polymer particle in the toner is preferably from 0.10 mass % to 8.00 mass %, or more preferably from 0.50 mass % to 5.00 mass %. If the content is within this range, long-term durability and low-temperature fixability can be further improved. The content of the organosilicon polymer particle can be controlled by controlling the added amount of the organosilicon polymer particle.

In transmission electron microscope (TEM) observation, the coverage of the shell layer by the organosilicon polymer particle is preferably at least 10%, or more preferably at least 30%. There is no particular upper limit, but preferably it is not more than 75%, or more preferably not more than 50%.

If the coverage of the shell layer by the organosilicon polymer particle is within this range, the long-term durability and environmental dependence of image quality can be easily improved. The coverage of the shell layer by the organosilicon polymer particle can be controlled by changing the manufacturing conditions and the balance between the added amount of the shell agent and the added amount of the organosilicon polymer particle.

The fixing index of the organosilicon polymer particle on a polycarbonate film as calculated by formula (I) below is preferably not more than 4.5, or more preferably not more than 4.3. There is no particular lower limit, but preferably it is at least 3.0, or more preferably at least 3.5.

If the fixing index is within this range, it is easy to suppress movement of the organosilicon polymer particle on the toner particle throughout long-term use, thereby improving long-term durability. The fixing index of the organosilicon polymer particle can be controlled by controlling Wa−Wb and changing the manufacturing conditions when adding the organosilicon polymer particle.

Fixing index=Area ratio A of organosilicon polymer particles moving to polycarbonate film/coverage B of organosilicon polymer particles on toner particle surface×100 (1)

The dispersity evaluation index of the organosilicon polymer particle on the toner surface is preferably from 0.5 to 2.0, or more preferably from 0.5 to 1.5.

Good charge distribution and improved image quality can be easily obtained if the dispersity evaluation index is within this range. The dispersity evaluation index of the organosilicon polymer particle can be controlled by changing the manufacturing conditions when adding the organosilicon polymer particle.

The organosilicon polymer particle is explained in detail. The organosilicon polymer particle is a resin particle composed of main chains produced by alternative binding of oxygen and silicon having organic groups.

The method for manufacturing the organosilicon polymer particle is not particularly limited, and for example it may be obtained by dripping a silane compound into water, hydrolyzing with a catalyst and performing a condensation reaction, after which the resulting suspension is filtered and dried. The number average particle diameter of the primary particles of the organosilicon compound can be controlled by means of the type of catalyst, the compounding ratio, the reaction initiation temperature, the dripping time and the like.

Examples of the catalyst include, but are not limited to, acidic catalysts such as hydrochloric acid, hydrofluoric acid, sulfuric acid and nitric acid and basic catalysts such as ammonia water, sodium hydrate and potassium hydroxide.

The organosilicon polymer particle has a structure produced by alternate binding of silicon atoms and oxygen atoms, and preferably has a T3 unit structure represented by formula (I) below.

In ²⁹Si-NMR measurement of the organosilicon polymer particle, the ratio of peak areas derived from silicon having a T3 unit structure with respect to the total area of peaks derived from all silicon element contained in the organosilicon polymer particle is preferably from 0.50 to 1.00, or more preferably from 0.60 to 0.98, or still more preferably from 0.70 to 0.95. Within this range, the effect of long-term durability is easily obtained because the organosilicon polymer particle acquires a suitable elasticity.

The ratio of peak areas derived from silicon having a T3 unit structure can be controlled by changing the types of organosilicon compounds used to polymerize the organosilicon polymer particle, and particularly by changing at least either the type or the ratio of a trifunctional silane.

R₁—SiO_{3/2} (1)

(In formula (1), R¹ represents a C₁₋₆ (preferably C₁₋₄, or more preferably C₁₋₂) alkyl group or phenyl group.)

The organosilicon polymer particle is preferably a condensation polymer of an organosilicon compound having a structure represented by formula (2) below.

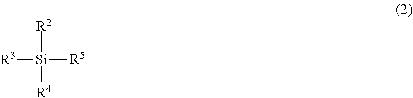

(in formula (2), each of R², R³, R⁴ and R⁵ independently represents a C₁₋₆ (preferably C₁₋₄, or more preferably C₁₋₂) alkyl group or phenyl group, or a reactive group such as a halogen atom, hydroxy group, acetoxy group or (preferably C₁₋₆, or more preferably C₁₋₃) alkoxy group.)

An organosilicon compound having four reactive groups in each formula (2) molecule (tetrafunctional silane),

an organosilicon compound having in formula (2) an alkyl group or phenyl group for R² and three reactive groups (R³, R⁴, R⁵) (trifunctional silane),

an organosilicon compound having in formula (2) an alkyl group or phenyl group for R² and R³ and two reactive groups (R⁴, R⁵) (difunctional silane), and

an organosilicon compound having in formula (2) an alkyl group or phenyl group for R², R³, and R⁴ and one reactive group (R⁵) (monofunctional silane) can be used to obtain the organosilicon polymer particles. The use of at least 50 mol % trifunctional silane for the organosilicon compound is preferred in order to obtain 0.50 to 1.00 for the proportion for the area of the peak originating with the T3 unit structure.

R² in formula (2) is preferably a C₁₋₆ (preferably C₁₋₄, or more preferably C₁₋₂) alkyl group or phenyl group. Preferably each of R³, R⁴ and R³ is independently a reactive group such as a halogen atom, hydroxy group, acetoxy group or (preferably C₁₋₆, or more preferably C₁₋₃) alkoxy group.

The organosilicon polymer particle can be obtained by causing the reactive groups to undergo hydrolysis, addition polymerization, and condensation polymerization to form a crosslinked structure. The hydrolysis, addition polymerization, and condensation polymerization of R3, R4, and R5 can be controlled by the reaction temperature, reaction time, reaction solvent, and pH.

The tetrafunctional silane can be exemplified by tetramethoxysilane, tetraethoxysilane, and tetraisocyanatosilane.

The trifunctional silane can be exemplified by methyltrimethoxysilane, methyltriethoxysilane, methyldiethoxymethoxysilane, methylethoxydimethoxysilane, methyitrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacctoxycthoxysilane, methylacetoxydimethoxysilane, methylacetoxymethoxyethoxysilane, methylacetoxydiethoxysilane, methyitrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichiorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilanc, butyltrichlorosilanc, butyltriacctoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, phenyltrihydroxysilane, and pentyltrimethoxysilane.

The difunctional silane can be exemplified by di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodinmethylsilane, dimethyldimethoxysilane, diethoxydimethylsilane, and diethyldimethoxysilane.

The monofunctional silane can be exemplified by t-butyldimethylchlorosilane, t-butyldimethylmethoxysilane, t-butyldimethylethoxysilane, t-butyldiphenylchlorosilane, t-butyldiphenylmcthoxysilane, t-butyldiphenylethoxysilane, chlorodimethylphenylsilane, methoxydimethylphenylsilane, ethoxydimethylphenylsilane, chlorotrimethylsilane, trimethylmethoxysilane, ethoxytrimethylsilane, triethylmethoxysilane, triethylethoxysilane, tripropylmethoxysilane, tributylmethoxysilane, tripentylmethoxysilane, triphenylchlorosilane, triphenylmethoxysilane, and triphenylethoxysilane.

The organosilicon polymer particles may be subjected to a surface treatment with the objective of providing it with hydrophobicity.

The hydrophobic treatment agent can be exemplified by chlorosilanes, e.g., methyitrichlorosilane, dimethyldichlorosilane, trimethylchlorosilane, phenyltrichlorosilane, diphenyldichlorosilane, t-butyldimethylchlorosilane, and vinyltrichlorosilane;

alkoxysilanes, e.g., tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, isobutyltrimethoxysilane, hexyltrimethoxysilane, octyltrimethoxysilane, decyltrimethoxysilane, dodecyltrimethoxysilane, tetraethoxysilane, methyltriethoxysilane, dimethyldiethoxysilane, phenyltriethoxysilane, diphenyldiethoxysilane, isobutyltriethoxysilane, decyltriethoxysilane, vinyltriethoxysilane, γ-methacryloxypropyltrinmethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxysilane, γ-aminopropyltriethoxysilane, γ-(2-aminoethyl)aminopropyltrimethoxysilane, γ-(2-aminoethyl)aminopropylmethyldimethoxysilane, and N-phenyl-3-aminopropyltrimethoxysilane, N-(2-aminoethyl)-3-aminopropyltrimethoxysilane, and N-β-(N-vinylbenzylaminoethyl)-γ-aminopropyltrimethoxysilane;

silazanes, e.g., hexamethyldisilazane, hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane;

silicone oils, e.g., dimethylsilicone oil, methylhydrogensilicone oil, methylphenylsilicone oil, alkyl-modified silicone oil, chloroalkyl-modified silicone oil, chlorophenyl-modified silicone oil, fatty acid-modified silicone oil, polyether-modified silicone oil, alkoxy-modified silicone oil, carbinol-modified silicone oil, amino-modified silicone oil, fluorine-modified silicone oil, and terminal-reactive silicone oil;

siloxanes, e.g., hexamethylcyclotrisiloxane, octamethylcyclotetrasiloxane, decamethylcyclopentasiloxane, hexamethyldisiloxane, and octamethyltrisiloxane; and

fatty acids and their metal salts, e.g., long-chain fatty acids such as undecylic acid, lauric acid, tridecylic acid, dodecylic acid, myristic acid, palmitic acid, pentadecylic acid, stearic acid, heptadecylic acid, arachidic acid, montanic acid, oleic acid, linoleic acid, and arachidonic acid, as well as salts of these fatty acids with metals such as zinc, iron, magnesium, aluminum, calcium, sodium, and potassium.

The use is preferred among the preceding of alkoxysilanes, silazanes, and silicone oils because they support facile execution of the hydrophobic treatment. A single one of these hydrophobic treatment agents may be used by itself or two or more may be used in combination.

The raw materials used in the toner particle are explained.

Specifically, the following polymers or the like may be used as binder resins for forming the core particle of the toner particle:

monopolymers of styrenes and substituted styrenes, such as polystyrene, poly-p-chlorostyrene and polyvinyl toluene; styrene copolymers such as styrene-p-chlorostyrene copolymers, styrene-vinyl toluene copolymers, styrene-vinyl naphthalene copolymers, styrene-acrylic acid ester copolymers and styrene-methacrylic acid ester copolymers; and polyvinyl chloride, phenol resin, natural resin-modified phenol resin, natural resin-modified maleic acid resin, acrylic resin, methacrylic resin, polyvinyl acetate, silicone resin, polyester resin, polyurethane resin, polyamide resin, furan resin, epoxy resin, xylene resin, polyethylene resin, polypropylene resin and the like.

The core particle preferably contains a release agent. An ester wax with a melting point of from 60° C. to 90° C. (more preferably from 60° C. to 80° C.) is preferred as a release agent to easily obtain a plasticizing effect due to its excellent compatibility with the binder resin.

Examples of ester waxes include waxes composed primarily of fatty acid esters, such as carnauba wax and montanic acid ester wax, and waxes such as deoxidized carnauba wax composed of fatty acid esters from which all or part of the oxygen component has been removed; methyl ester waxes with hydroxy groups obtained by hydrogenation of vegetable oils and fats; saturated fatty acid monoesters such as stearyl stearate and behenyl behenate; diesters of saturated aliphatic dicarboxylic acids and saturated aliphatic alcohols, such as dibehenyl sebacate, distearyl dodecanedioate and distearyl octadecanedioate; and diesters of saturated aliphatic diols and saturated aliphatic monocarboxylic acids, such as nonanediol dibehenate and dodecanediol distearate.

Of these waxes, it is desirable to include a bifunctional ester wax (diester) having two ester bonds in the molecular structure.

A bifunctional ester wax is an ester compound of a dihydric alcohol and an aliphatic monocarboxylic acid or an ester compound of a divalent carboxylic acid and an aliphatic monoalcohol.

Specific examples of the aliphatic monocarboxylic acid include myristic acid, palmitic acid, stearic acid, arachidic acid, behenic acid, lignoceric acid, cerotic acid, montanic acid, melissic acid, oleic acid, vaccenic acid, linoleic acid, linolenic acid and the like.

Specific examples of the aliphatic monoalcohol include myristyl alcohol, cetanol, stearyl alcohol, arachidyl alcohol, behenyl alcohol, tetracosanol, hexacosanol, octacosanol, triacontanol and the like.

Specific examples of the divalent carboxylic acid include butanedioic acid (succinic acid), pentanedioic acid (glutaric acid), hexanedioic acid (adipic acid), heptanedioic acid (pimelic acid), octanedioic acid (suberic acid), nonanedioic acid (azelaic acid), decanedioic acid (sebacic acid), dodecanedioic acid, tridecanedioic acid, tetradecanedioic acid, hexadecanedioic acid, octadecanedioic acid, eicosanedioic acid, phthalic acid, isophthalic acid, terephthalic acid and the like.

Specific examples of the dihydric alcohol include ethylene glycol, propylene glycol, 1,3-propanediol, 1,4-butanediol, 1,3-pentanediol, 1,6-hexanediol, 1,10-decanediol, 1,12-dodecanediol, 1,14-tetradecanediol, 1,16-hexadecanediol, 1,18-octadecanediol, 1,20-eicosanediol, 1,30-triacontanediol, diethylene glycol, dipropylene glycol, 2,2,4-trimethyl-1,3-pentanediol, neopentyl glycol, 1,4-cyclohexanedimethanol, spiroglycol, 1,4-phenylene glycol, bisphenol A, hydrogenated bisphenol A and the like.

Other release agents that can be used include petroleum waxes such as paraffin wax, microcrystalline wax and petrolatum, and derivatives thereof, montanic wax and derivatives thereof, hydrocarbon waxes obtained by the Fischer-Tropsch method and derivatives thereof, polyolefin waxes such as polyethelene and polypropylene, and derivatives thereof, natural waxes such as carnauba wax and candelilla wax, and derivatives thereof, higher aliphatic alcohols, and fatty acids such as stearic acid and palmitic acid and the like.

The content of the release agent is preferably from 5.0 mass parts to 20.0 mass parts per 100.0 mass parts of the binder resin.

The core particle may also contain a colorant. Examples of colorants include the following.

Examples of black colorants include carbon black and blacks obtained by blending yellow, magenta and cyan colorants. A pigment may be used alone as a colorant, but from the standpoint of the image quality of full-color images, it is desirable to combine a dye and a pigment to improve sharpness.

Examples of pigments for magenta toners include C.I. pigment red 1, 2, 3, 4, 5, 6, 7, 8, 9, 10, 11, 12, 13, 14, 15, 16, 17, 18, 19.21, 22, 23, 30, 31, 32, 37, 38, 39, 40, 41, 48:2, 48:3, 48:4, 49, 50, 51, 52, 33, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269 and 282; C.I. pigment violet 19; and C.I. vat red 1, 2, 10, 13, 15, 23, 29 and 35.

Examples of dyes for magenta toners include oil-soluble dyes such as C.I. solvent red 1, 3, 8, 23, 24, 25, 27, 30, 49, 81, 82, 83, 84, 100, 109 and 121, C.I. disperse red 9, C.I. solvent violet 8, 13, 14, 21 and 27 and C.I. disperse violet 1; and basic dyes such as C.I. basic red 1, 2, 9, 12, 13, 14, 15, 17, 18, 22, 23, 24, 27, 29, 32, 34, 35, 36, 37, 38, 39 and 40 and C.I. basic violet 1, 3, 7, 10, 14, 15, 21, 25, 26, 27 and 28.

Examples of pigments for cyan toners include C.I. pigment blue 2, 3, 15:2, 15:3, 15:4, 16 and 17; C.I. vat blue 6; C.I. acid blue 45, and copper phthalocyanine pigments comprising 1 to 5 phthalimidomethyl groups substituted on a phthalocyanine skeleton.

Examples of dyes for cyan toners include C.I. solvent blue 70.

Examples of pigments for yellow toners include C.I. pigment yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181 and 185; and C.I. vat yellow 1, 3 and 20.

Examples of dyes for yellow toners include C.I. solvent yellow 162.

These colorants may be used individually, or mixed, or used in a solid solution. The colorants are selected out of considerations of hue angle, color saturation, lightness, light resistance, OHP transparency and toner dispersibility.

The content of the colorant is preferably from 0.1 mass parts to 30.0 mass parts per 100.0 mass parts of the binder resin.

A magnetic material may be contained as a colorant in the core particle to produce a magnetic toner particle. Examples of magnetic materials include iron oxides such as magnetite, hematite and ferrite; metals such as iron, cobalt and nickel or alloys of these metals with other metals such as aluminum, copper, magnesium, tin, zinc, beryllium, calcium, manganese, selenium, titanium, tungsten and vanadium, and mixtures of these.

The magnetic material is preferably a magnetic material that has been surface modified.

When preparing a magnetic toner by a polymerization method, hydrophobic treatment is preferably performed with a surface modifier that is a material that does not inhibit polymerization. Examples of such surface modifiers include silane coupling agents and titanium coupling agents.

The number average particle diameter of these magnetic materials is preferably not more than 2.0 microns, or more preferably from 0.1 microns to 0.5 microns.

The content of the magnetic material is preferably from 20 mass parts to 200 mass parts, or more preferably from 40 mass parts to 150 mass parts per 100 mass parts of the binder resin.

The core particle may contain a charge control agent. Examples of charge control agents for controlling the negative charging properties of the toner include the following.

Examples of organic metal compounds and chelate compounds include monoazo metal compounds, acetylacetone metal compounds, and metal compounds of aromatic oxycarboxylic acids, aromatic dicarboxylic acids, oxycarboxylic acids and dicarboxylic acids. Other examples include aromatic oxycarboxylic acids and aromatic mono- and polycarboxylic acids and metal salts, anhydrides or esters thereof, and phenol derivatives such as bisphenols. Other examples include urea derivatives, metal-containing salicylic acid compounds, metal-containing naphthoic acid compounds, boron compounds, quaternary ammonium salts and calixarenes.

Examples of charge control agents for controlling the positive charging properties of the toner include nigrosine modified products of nigrosine and fatty acid metal salts; guanidine compounds; imidazole compounds; quaternary ammonium compounds such as tributyl benzyl ammonium-1-hydroxy-4-naphtholsulfonic acid salt, tetrabutyl ammonium tetrafluoroborate and (3-acrylamidopropyl) trimethyl ammonium chloride, analogs thereof that are onium salts such as phosphonium salts, and lake pigments of these; triphenylmethane dyes and lake pigments thereof (using phosphotungstic acid, phosphomolybdic acid, phosphotungstic molybdic acid, tannic acid, lauric acid, gallic acid or a ferricyanide or ferrocyanide as the laking agent); metal salts of higher fatty acids; and resin-based charge control agents.

One of these charge control agents alone or a combination of two or more may be used. The added amount of these charge control agents is preferably from 0.01 mass parts to 10.00 mass parts per 100.0 mass parts of the binder resin or the polymerizable monomers for producing the binder resin.

The method for manufacturing the core particle of the toner particle is explained. Known techniques may be used for manufacturing the core particle, and a wet manufacturing method such as a suspension polymerization method, emulsion polymerization and aggregation method or emulsion aggregation method or a kneading pulverization method may be used.

In suspension polymerization methods, a core particle is manufactured by way of a granulation step in which a polymerizable monomer composition containing a polymerizable monomer for producing a binder resin together with additives such as a colorant and wax as necessary is dispersed in an aqueous medium to form droplet particles of the polymerizable monomer composition, and a polymerization step in which the polymerizable monomer contained in the droplet particles is polymerized to manufacture the core particle.

Examples of preferred polymerizable monomers include vinyl polymerizable monomers. Specific examples include the following.

Examples include styrene; styrene derivatives such as α-methylstyrene, β-methylstyrene, o-methylstyrene, m-methylstyrene, β-methylstyren and 2,4-dimethylstyrene; acrylic polymerizable monomers such as methyl acrylate, ethyl acrylate, n-propyl acrylate, iso-propyl acrylate, n-butyl acrylate, iso-butyl acrylate, tert-butyl acrylate and 2-ethylhexyl acrylate; methacrylic polymerizable monomers such as methyl methacrylate, ethyl methacrylate, n-propyl methacrylate, iso-propyl methacrylate, n-butyl methacrylate, iso-butyl methacrylate and tert-butyl methacrylate; methylene aliphatic monocarboxylic acid esters; and vinyl esters such as vinyl acetate, vinyl propionate, vinyl benzoate, vinyl butyrate, vinyl formate and the like.

In emulsion aggregation methods, an aqueous dispersion of a fine particle consisting of the constituent materials of the toner particle (core particle) and with a particle diameter sufficiently smaller than the target particle diameter is prepared in advance, this fine particle is aggregated in an aqueous medium until the particle diameter of the toner is reached, and the resin is fused by heating to manufacture the toner.

Preferably an emulsion aggregation method includes a dispersal step of preparing a fine particle dispersion containing the constituent materials of the toner (core particle), an aggregation step of aggregating the fine particles containing the constituent materials of the toner (core particle) and controlling the particle diameter until the particle diameter of the toner (core particle) is reached to obtain aggregated particles, and a fusion step of fusing the resin contained in the resulting aggregated particles. After this, a cooling step, a filtration and washing step in which the resulting toner (core particle) is filtered and washed with deionized water, and a drying step to remove the moisture contained in the washed toner (core particle) may also be included as necessary.

One example of a manufacturing method for manufacturing the core particle of the toner particle by a kneading pulverization method is explained.

In a raw material mixing step, a binder resin and additives such as a colorant and wax as necessary are weighed in predetermined amounts, mixed and compounded as materials for constituting the core particle.

The mixing apparatus may be a double cone mill, V mixer, drum mixer, Super mixer, FM mixer, Nauta mixer, Mechano Hybrid (Nippon Coke & Engineering) or the like for example.

The mixed materials are then melt kneaded to disperse the colorant, wax and the like in the binder resin. Either a batch kneader such as a pressure kneader or Banbury mixer or a continuous kneading apparatus may be used in the melt kneading step. A single-screw or twin-screw extruder is commonly used because of the superiority of continuous production.

Examples include a KTK twin-screw extruder (Kobe Steel, Ltd.), TEM twin-screw extruder (Toshiba Machine Co., Ltd.), PCM extruder (Ikegai), twin-screw extruder (KCK), Co-Kneader (Buss Corp.). Kneadex (Nippon Coke & Engineering) and the like. The resin composition obtained by melt kneading may be further rolled with a twin roller or the like or cooled with water or the like in a cooling step.

The cooled resin composition is then pulverized to the desired particle diameter in a pulverization step.

In the pulverization step, the composition is first coarsely pulverized with a crushing apparatus such as a crusher, hammer mill, feather mill or the like for example. It is then finely pulverized with a pulverizing apparatus such as a Cryptron system (Kawasaki Heavy Industries), Super Rotor (Nisshin Engineering) or Turbo Mill (Freund Turbo) or a pulverizing apparatus using an air jet system for example.

This is then classified as necessary with a classifier or sieving apparatus such as an Elbow-Jet (Nittetsu Mining) using an inertial classification system, a Turboplex (Hosokawa Micron) using a centrifugal classification system, or a TSP Separator (Hosokawa Micron) or Faculty (Hosokawa Micron) to obtain the core particle.

The core particle may also be spheronized. For example, spheronization may be performed after pulverization using a Hybridization System (Nara Machinery), a Mechanofusion System (Hosokawa Micron), a Faculty (Hosokawa Micron) or a Meteor Rainbow MR Type (Nippon Pneumatic Mfg. Co., Ltd.).

The glass transition temperature (Tg) of the core particle is preferably from 40° C. to 60° C. from the standpoint of low-temperature fixability.

The shell layer of the toner particle is explained.

The shell layer contains a compound containing nitrogen atoms.

The compound containing nitrogen atoms that is contained in the shell layer may be a resin as a simple substance, or a resin containing nitrogen atoms. More preferably the shell layer contains a resin containing nitrogen atoms, and more preferably is a resin containing nitrogen atoms.

Examples of resins containing nitrogen atoms include aminoaldehyde resins, vinyl resins containing nitrogen atoms, polyimide resins (specifically, maleimide polymers and bismaleimide polymers, etc.) and xylene resins.

Examples of aminoaldehyde resins include melamine resins, urea resins, sulfonamide resins, glyoxal resins, guanamine resins and aniline resins.

The shell layer preferably has at least one selected from the group consisting of a melamine resin, a urea resin and a resin containing oxazoline groups. Long-term durability is improved more easily if the shell layer contains such a resin. The shell layer is more preferably at least one selected from the group consisting of a melamine resin, a urea resin and a resin containing oxazoline groups.

Examples of the nitrogen atom-containing compound contained in the resin include 2-vinyl-2-oxazoline, N,N,N-trimethyl-N-(2-methacryloxyethyl) ammonium chloride (dimethyl aminoethyl methyl methacrylate chloride (DMC)), N-benzyl-N,N-dimethyl-N-(2-methacryloxyethyl) ammonium chloride (dimethyl aminoethyl benzyl methacrylate chloride (DML)), tributyl benzyl ammonium-1-hydroxy-4-naphtholsulfonic acid salt, tetrabutyl ammonium tetrafluoroborate, (3-acrylamidopropyl) trimethylammonium chloride and the like.

These monomers may be used individually, or two or more may be combined.

These monomers may or may not be bound to the resin (by covalent bonding for example).

The melamine resin is preferably a methylol melamine resin, hexamethylol melamine resin or methoxymethylol melamine resin.

The urea resin is preferably a methylol urea resin.

A vinyl resin containing nitrogen atoms is a vinyl resin containing monomers units containing nitrogen atoms. Examples of monomers for forming the monomer units containing nitrogen atoms include the nitrogen atom-containing compounds described above. For example, this may be at least one selected from the group consisting of 2-vinyl-2-oxazoline and (3-acrylamidopropyl) trimethyl ammonium chloride, and 2-vinyl-2-oxazoline is more preferred.

The content of the monomer units containing nitrogen atoms in the vinyl resin containing nitrogen atoms is preferably from 50 mass % to 95 mass %, or more preferably from 75 mass % to 92 mass %.

A resin containing oxazoline groups is preferably a vinyl resin containing monomer units containing oxazoline groups, and more preferably has monomer units obtained by vinyl polymerization of 2-vinyl-2-oxazoline.

The vinyl polymerizable monomers described above may be used for the vinyl resin. An acrylic polymerizable monomer or methacrylic polymerizable monomer is preferred. A (meth)acrylic acid ester having C₁₋₄ alkyl groups, such as methyl (meth)acrylate or butyl (meth)acrylate, is more preferred.

The methods for obtaining the toner particle by forming the shell layer on the core particle surface are not particularly limited. When the core particle is manufactured by a method that includes a wet process such as suspension polymerization, emulsion polymerization and aggregation or emulsion aggregation, the compound for forming the shell layer can be added to the liquid after the core particle is manufactured to form the shell layer.

When the core particle is manufactured by a pulverization method, the core particle can be dispersed in an aqueous medium to form the shell layer after the core particle is manufactured.

In either case, the compound for forming the shell layer may be added as a dispersion to form the shell layer, or else the monomer raw materials of the shell layer can be added to the dispersed core particle and polymerized to form the shell layer.

The shell layer may also be formed by adding a fine particle of a nitrogen atom-containing compound as a dry powder to the core in a dry powder state.

When the compound of the shell layer is added to the core particle as a fine particle, the resin adhering to the core particle in the form of fine particles can be made into a film to form the shell layer by heating.

The content of the shell layer is preferably from 0.4 mass parts to 6.5 mass parts, or more preferably from 0.5 mass parts to 2.0 mass parts per 100 mass parts of the core particle.

The toner can be obtained by mixing the toner particle together with an organosilicon polymer particle and other additives as necessary. The mixing apparatus for mixing the toner particle with the additives may be an FM Mixer (Nippon Coke and Engineering), Super Mixer (Kawata), Nobilta (Hosokawa Micron) or Hybridizer (Nara Machinery).

Coarse particles may also be sieved out after mixing the external additives. Examples of the sieving apparatus used therefor include the following:

Ultrasonic (Koei Sangyo Co., Ltd.), Resona Sieve, Gyro Sifter (Tokuju Kogyo), Vibrasonic System (Dalton), Soniclean (Sintokogio, Ltd.), Turbo Screener (Freund Turbo), Microsifner (Makino Sangyo).

The toner may also contain another external additive apart from the organosilicon polymer particle. In particular, a flowability improver may be added to improve the flowability or chargeability of the toner.

Examples of flowability improvers include fluorine resin powders such as vinylidene fluoride fine powder and polytetrafluoroethylene fine powder; finely powdered silica particles such as wet process silica or dry process silica, and finely powdered titanium oxide particles and finely powdered alumina particles; hydrophobic silica fine particles obtained by surface treating these particles with hydrophobizing agents such as silane compounds, titanium coupling agents or silicone oil; oxides such as zinc oxide and tin oxide; composite oxides such as strontium titanate, barium titanate, calcium titanate, strontium zirconate and calcium zirconate; and carbonate compounds such as calcium carbonate and magnesium carbonate.

Of these, a fine particle produced by vapor phase oxidation of a silicon halide compound is preferred as a flowability improver. Dry manufacturing method silica fine particles (called dry process silica or fumed silica) are preferred.

The dry manufacturing method is for example a method using a pyrolysis oxidation reaction of silicon tetrachloride gas in an oxyhydrogen flame, and the basic reaction formula is as follows.

SiCl₄+2H₂+O₂→SiO₂+4HCl

In this manufacturing step, a composite fine particle of silica with another metal oxide can be obtained by using another metal halide compound such as aluminum chloride or titanium chloride together with the silicon halide compound, and such particles are considered a silica fine particle.

This flowability improver preferably has a number average particle diameter of from 5 nm to 10 nm of the primary particles in order to impart a high degree of chargeability and flowability.

A hydrophobically treated silica fine particle that has been surface treated with a hydrophobic treatment agent is more preferred as a flowability improver.

The flowability improver preferably has a specific surface area of from 30 m²/g to 300 m²/g as measured by nitrogen adsorption by the BET method.

The content of the flowability improver is preferably from 0.01 mass parts to 3.0 mass parts per 100 mass parts of the toner particle.

The Methods for Measuring the Various Physical Properties are Explained, Method for Measuring Number Average Particle Diameter of Primary Particles of Organosilicon Polymer Particle

Measurement of the number average primary particle diameter of the organosilicon polymer particle is performed using an “S-4800” scanning electron microscope (product name, Hitachi, Ltd.). Observation is carried out on the toner to which organosilicon polymer particles have been added; in a visual field enlarged by a maximum of 50,000×, the long diameter of the primary particles of 100 randomly selected organosilicon polymer particles is measured; and the number average particle diameter is determined. The enlargement factor in the observation is adjusted as appropriate depending on the size of the organosilicon polymer particle.

When the organosilicon polymer particles can be independently acquired as such, measurement can also be performed on these organosilicon polymer particles as such.

When the toner contains silicon-containing material other than the organosilicon polymer particles, EDS analysis is carried out on the individual particles of the external additive during observation of the toner and the determination is made, based on the presence/absence of a peak for the element Si, as to whether the analyzed particles are organosilicon polymer particles.

When the toner contains both organosilicon polymer particles and silica fine particles, the organosilicon polymer particles are identified by comparing the ratio (Si/O ratio) for the Si and O element contents (atomic %) with a standard. EDS analysis is carried out under the same conditions on standards for both the organosilicon polymer particles and silica fine particles to obtain the element content (atomic %) for both the Si and O. Using A for the Si/O ratio for the organosilicon polymer particles and B for the Si/O ratio for the silica fine particles, measurement conditions are selected whereby A is significantly larger than B. Specifically, the measurement is run ten times under the same conditions on the standards and the arithmetic mean value is obtained for both A and B. Measurement conditions are selected whereby the obtained average values satisfy A/B>1.1.

When the Si/O ratio for a fine particle to be classified is on the A side from [(A+B)/2], the fine particle is then scored as an organosilicon polymer particle.

Tospearl 120A (Momentive Performance Materials Japan LLC) is used as the standard for the organosilicon polymer particles, and HDK V15 (Asahi Kasei Corporation) is used as the standard for the silica fine particles.

Identifying Organosilicon Polymer Particle and Confirming T3 Unit Structure

Pyrolysis gas chromatography/mass spectrometry (hereunder also called pyrolysis GC/MS) and NMR are used to identify the composition and proportions of the constituent compounds of the organosilicon polymer particle contained in the toner.

When the toner contains a silicon-containing material or external additive other than the organosilicon polymer particle, the toner is dispersed in a solvent such as chloroform, and the organosilicon polymer particle is then separated by centrifugation or the like based on the difference in specific gravity. The methods are as follows.

First, 31 g of chloroform is placed in a vial, 1 g of the toner is added to disperse the toner, and the organosilicon polymer particle and other external additives and the like are separated from the toner. The dispersion is prepared by treating the toner for 30 minutes with an ultrasonic homogenizer. The treatment conditions are as follows.

ultrasound treatment instrument: VP-050 ultrasound homogenizer (TIETECH Co., Ltd.)
microtip: stepped microtip, 2 mmϕ end diameter
position of microtip end: center of glass vial, 5 mm height from bottom of vial
ultrasound conditions: 30% intensity, 30 minutes; during this treatment, the ultrasound is applied while cooling the vial with ice water to prevent the temperature of the dispersion from rising

The dispersion is transferred to a glass tube (50 mL) for swing rotor service, and centrifugal separation is carried out using a centrifugal separator (H-9R, Kokusan Co., Ltd.) and conditions of 58.33 S⁻¹ for 30 minutes.

After centrifugation, a fraction containing mainly the organosilicon polymer particle in the glass tube can be separated based on specific gravity. The resulting fraction is dried under vacuum conditions (40° C./24 hours) to obtain a sample.

When the organosilicon polymer particle can be obtained alone, the organosilicon polymer particle can also be measured by itself.

Using the sample obtained by the above or organosilicon polymer particles, the abundance of the constituent compounds of the organosilicon polymer particles and proportion for the T3 unit structure in the organosilicon polymer particles is then measured and calculated using solid-state ²⁹Si-NMR.

Pyrolysis GC/MS is used for analysis of the species of constituent compounds of the organosilicon polymer particles.

The species of constituent compounds of the organosilicon polymer particles are identified by analysis of the mass spectrum of the pyrolyzate components derived from the organosilicon polymer particles and produced by pyrolysis of the toner at 550° C. to 700° C. The specific measurement conditions are as follows.

Measurement Conditions for Pyrolysis GC/MS

pyrolysis instrument: JPS-700 (Japan Analytical Industry Co., Ltd.)
pyrolysis temperature: 590° C.
GC/CMS instrument: Focus GC/ISQ (Thermo Fisher)
column: HP-5MS, 60 m length, 0.25 mm inner diameter, 0.25 μm film thickness
injection port temperature: 200° C.
flow pressure: 100 kPa
split: 50 ml/min
MS ionization: EI
ion source temperature: 200° C., mass range 45 to 650

The abundance of the identified constituent compounds of the organosilicon polymer particles is then measured and calculated using solid-state ²⁹Si-NMR.

In solid-state ²⁹Si-NMR, peaks are detected in different shift regions depending on the structure of the functional groups bonded to the Si in the constituent compounds of the organosilicon polymer particles.

The structure of the functional groups of each peak is identified by using a reference sample. The abundance of each constituent compound is calculated from the obtained peak areas. The determination can be carried out by calculating the proportion for the peak area for the T3 unit structure with respect to total peak area.

The measurement conditions for the solid-state ²⁹Si-NMR are as follows.

instrument: JNM-ECX5002 (JEOL RESONANCE)
temperature: room temperature
measurement method: DDMAS method, 29Si, 45°
sample tube: zirconia 3.2 mmϕ
sample: filled in powder form into the sample tube
sample rotation rate: 10 kHz
relaxation delay: 180 s
scans: 2,000

After this measurement, peak separation is performed, for the chloroform-insoluble matter of the organosilicon polymer particles, into the following structure X1, structure X2, structure X3, and structure X4 by curve fitting for silane components having different substituents and bonding groups, and their respective peak areas are calculated.

The structure X3 indicated below is the T3 unit structure.

structure X1: (Ri)(Rj)(Rk)SiO_{1/2} (A1)

structure X2: (Rg)(Rh)Si(O_{1/2})₂ (A2)

structure X3: RmSi(O_{1/2})₃ (A3)

structure X4: Si(O_{1/2})₄ (A4)

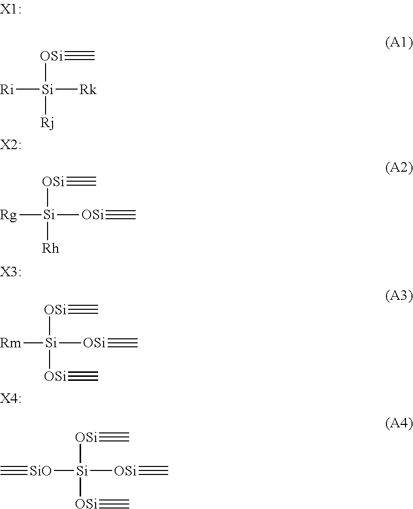

The Ri, Rj, Rk, Rg, Rh, and Rm in formulas (A1), (A2), and (A3) represent a silicon-bonded organic group. e.g., a hydrocarbon group having from 1 to 6 carbons, halogen atom, hydroxy group, acetoxy group, or alkoxy group.

The hydrocarbon group represented by the aforementioned R¹ is identified by ¹³C-NMR.

Measurement Conditions for ¹³C-NMR (Solid State)

instrument: JNM-ECX500II from JEOL RESONANCE, Inc.
sample tube: 3.2 mmϕ
sample: filled in powder form into the sample tube
measurement temperature: room temperature
pulse mode: CP/MAS
measurement nucleus frequency: 123.25 MHz (¹³C)
reference material: adamantane (external reference: 29.5 ppm)
sample rotation rate: 20 kHz
contact time: 2 ms
retardation time: 2 s
cumulative number: 1024

In this method, the hydrocarbon group represented by R¹ is confirmed by the presence/absence of a signal originating with, e.g., the silicon atom-bonded methyl group (Si—CH₃), ethyl group (Si—C₂H₅), propyl group (Si—C₃H₇), butyl group (Si—C₄H₉), pentyl group (Si—C₅H₁₁), hexyl group (Si—C₆H₁₃), or phenyl group (Si—C₆H₅).

When a finer structural discrimination is necessary, identification may be carried out using the results of ¹H-NMR measurement together with the results of the aforementioned ¹³C-NMR measurement and ²⁹Si-NMR measurement.

Method for Assaying Organosilicon Polymer Particle Contained in Toner

The content of the organosilicon polymer particle in the toner is measured by fluorescent x-rays.

The x-ray fluorescence measurement is based on JIS K 0119-1969, and specifically is carried out as follows. An “Axios” wavelength-dispersive x-ray fluorescence analyzer (PANalytical B.V.) is used as the measurement instrument, and the “SuperQ ver. 5.0 L” (PANalytical B.V.) software provided with the instrument is used in order to set the measurement conditions and analyze the measurement data. Rh is used for the x-ray tube anode; a vacuum is used for the measurement atmosphere; and the measurement diameter (collimator mask diameter) is 27 mm. With regard to the measurement, measurement is carried out using the Omnian method in the element range from F to U, and detection is carried out with a proportional counter (PC) in the case of measurement of the light elements and with a scintillation counter (SC) in the case of measurement of the heavy elements.

The acceleration voltage and current value for the x-ray generator are established so as to provide an output of 2.4 kW. For the measurement sample, 4 g of the toner is introduced into a specialized aluminum compaction ring and is smoothed over, and, using a “BRE-32” tablet compression molder (Maekawa Testing Machine Mfg. Co., Ltd.), a pellet is produced by molding to a thickness of 2 mm and a diameter of 39 mm by compression for 60 seconds at 20 MPa, and this pellet is used as the measurement sample.

X-ray exposure is carried out on the pellet molded under the aforementioned conditions, and the resulting characteristic x-rays (fluorescent x-rays) are dispersed with a spectroscopic element. The intensity of the fluorescent x-rays dispersed at the angle corresponding to the wavelength specific to each element contained in the sample is analyzed by the fundamental parameter method (FP method), the content ratio for each element contained in the toner is obtained as a result of the analysis, and the silicon atom content in the toner is determined.

The content of the organosilicon polymer particles in the toner can be obtained by calculation from the relationship between the silicon content in the toner that is determined by x-ray fluorescence and the content ratio for the silicon in the constituent compounds of the organosilicon polymer particles for which the structure has been established using, e.g., solid-state ²⁹Si-NMR and pyrolysis GC/MS.

When a silicon-containing material other than the organosilicon polymer particles is contained in the toner, using the same methods as described above, a sample provided by the removal from the toner of the silicon-containing material other than the organosilicon polymer particles, can be obtained and the organosilicon polymer particles contained in the toner can be quantitated.

Isolating R-Sin and the Like Constituting Shell Laver

The resin constituting the shell layer which is separated from the toner can be used for each analysis by the following methods.

The methods for separating the resin constituting the shell layer from the toner are explained. The resin constituting the shell layer is separated from the toner and fractionated by gradient separation using a gradient polymer elution chromatograph (device name: UltiMate 3000 HPLC. Thermo Fisher Scientific).

The toner is dissolved in chloroform to prepare a 1 mass % toner solution. The toner solution is injected into the gradient polymer elution chromatograph, and a chromatogram of the solvent gradient is obtained. The peak components are identified in the resulting chromatogram, the toner solution is then injected again, and each component is then fractionated with an aliquot unit and dried to separate the resin constituting the shell layer.

the conditions for gradient polymer elution chromatography are as follows.

eluent: Gradient from 100% ACN acetonitrile to 100% chloroform (25 minutes)
column: ODS column
column oven: 40° C.
flow rate: 1 ml/min

Identifying Compounds contained in Shell Layer

The composition and ratios of the constituent compounds of the shell layer are identified using pyrolysis gas chromatography mass spectrometry (hereunder also called “pyrolysis GC/MS”) and NMR. If the compounds constituting the shell layer can be obtained individually, they can also be measured individually.

Pyrolysis GC/MS is used to analyze the types of constituent compounds in the shell layer. The resin of the shell layer is pyrolyzed at 550° C. to 700° C., and the types of the constituent compounds of the shell layer are identified by analyzing the mass spectrum of the resulting decomposition products of the thermoplastic resin of the shell layer. The specific measurement conditions are as follows.

Pyrolysis GC/MS Measurement Conditions

pyrolysis instrument: JPS-700 (Japan Analytical Industry Co., Ltd.)
pyrolysis temperature: 590° C.
GC/MS instrument: Focus GC/ISQ (Thermo Fisher)
column: HP-SMS, length 60 m, inner diameter 0.25 mm, thickness 0.25 μm
injection port temperature: 200° C.
flow pressure: 100 kPa
split: 50 ml/min
MS ionization: EI
ion source temperature: 200° C., mass range 45 to 650

The abundance ratios of the identified constituent components of the shell layer are then measured and calculated by solid ¹H-NMR. Structural determination is performed by nuclear magnetic resonance spectroscopy (¹H-NMR, 400 MHz, CDCl₃, room temperature (25° C.)).

measurement instrument: FT NMR instrument JNM-EX400 (JEOL)
measurement frequency: 400 MHz
pulse condition: 5.0 μs
frequency range: 10,500 Hz
cumulative number: 64

The molar ratio of each monomer component is determined from the integrated value of the resulting spectrum and used to calculate the compositional ratio (mol %).

Measuring Work Functions of Toner Particle and Organosilicon Polymer Particle

The work function of the toner particle is measured by the following methods.

The work function is a numerical value representing the energy (eV) required to extract electrons from the substance.

The work function is measured using a surface analyzer (Riken Keiki Co., Ltd. AC-2).

With this unit, measurement is performed under the following conditions using a deuterium lamp.

exposure dose: 800 nW
spectrometer: monochromatic light
spot size: 4 [mm]×4 [mm]
energy scanning range: 3.6 to 6.2 [eV]
anode voltage: 2910 V
measurement time: 10 [sec/l point]

The photoelectrons emitted from the sample surface are then detected and subjected to arithmetic processing using the work function calculation software incorporated in the surface analyzer. The work function is measured with a repeat accuracy (standard deviation) of 0.02 eV. A powder measurement cell is used for measuring powder samples.

When the excitation energy of monochromatic light is scanned from low to high in 0.1 [eV] increments in this surface analysis, photoelectron emission begins at a certain energy value [eV], and this threshold energy value is given as the work function [eV].

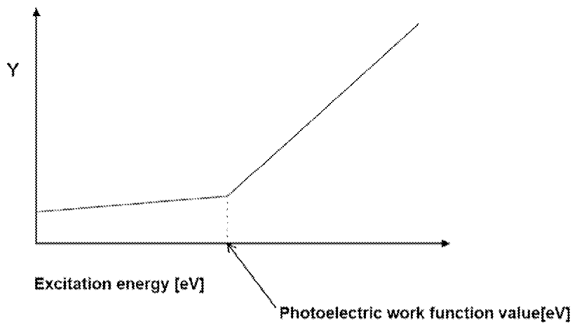

FIG. 1 shows one example of a work function measurement curve obtained by measurement under these conditions.

In FIG. 1, the excitation energy [eV] is shown on the horizontal axis, while the vertical axis shows the value Y of the number of emitted photoelectrons taken to the 0.5th power (standardized photoelectron yield). In general, photoelectrons are emitted suddenly (or in other words the standardized photoelectron yield suddenly increases) when the excitation energy value passes a given threshold, and the work function measurement curve rises rapidly as a result. This rising point is defined as the photoelectric work function value [Wf]. This photoelectric work function value [Wf] is given as the work function of the sample.

Either the toner particle or the organosilicon polymer particle is used as the sample for measuring the work function.

The organosilicon polymer particle separated from the toner by the methods described above may be used.

For the toner particle, a toner particle obtained by removing external additives from the toner by the methods described below may be used as the sample.

160 g of sucrose (Kishida Chemical) is added to 100 ml of deionized water and dissolved while using a hot water bath to prepare a concentrated sucrose solution. 31 g of this concentrated sucrose solution and 6 ml of Contaminon N are placed in a centrifuge tube to prepare a dispersion solution. 1 g of toner is added to this dispersion solution, and clumps of toner are broken up with a spatula or the like.

The centrifuge tube is shaken for 20 minutes in a shaker at 350 spm with an lwaki KM Shaker (model: V-SX). After shaking, the solution is transferred to a glass tube (50 ml) of a swing rotor, and separated under conditions of 3,500 rpm, 30 minutes with a centrifuge. The toner particle is contained in the uppermost layer in the glass tube after centrifugation, while the external additives are contained in the aqueous solution of the lower layer. The toner particle in the uppermost layer is separated. Centrifugation may also be repeated as necessary to achieve thorough separation.

Confirming Presence of Nitrogen Atoms in Shell Laver

The presence or absence of nitrogen atoms in the shell layer of the toner particle is measured in a cross-sectional image of the toner observed under a transmission electron microscope.

The toner is thoroughly dispersed in a visible-light-curable resin (Aronix LCR series D800) and then cured by exposure to short wavelength light. The cured product is cut with an ultramicrotome equipped with a diamond knife to prepare a 250 nm sample in the form of a flake. A cross-section of the toner particle is observed by observing the cut sample at a magnification of 40,000× to 50,000× using a transmission electron microscope (JEOL Ltd. JEM-2800 electron microscope) (TEM-EDX), and element mapping is performed using EDX to confirm the presence of nitrogen atoms.

The toner cross-section for observation is selected as follows. First, the cross-sectional area of the toner is determined from a cross-sectional image of the toner, and the diameter of a circle having the same area as the cross-sectional area (circle equivalent diameter) is obtained. Observations are performed only with respect to cross-sectional images of the toner in which the absolute value of the difference between the circle equivalent diameter and the weight-average particle diameter (D4) of the toner is within 1.0 microns.

Method for Measuring Thickness and Coverage Ratio of Shell Layer

The presence or absence of the toner particle shell layer and the thickness and coverage of the shell layer are measured in cross-sectional images of the toner obtained with a transmission electron microscope. Toner cross-sections for transmission electron microscope observation are prepared as follows.

The procedures for preparing a ruthenium dyed toner cross-section are explained here.

First, the toner is scattered as a single layer on a cover glass (Matsunami Glass square cover glass: Square No. 1). Next, an OPC80T Osmium Plasma Coater (filgen) is used to give the toner an Os film (5 nm) and naphthalene film (20 nm) as protective films.

A PTFE tube (inner diameter Φ1.5 mm×outer diameter Φ3 mm×Φ3 mm) is filled with D800 photocurable resin (JEOL), and the cover glass is placed gently on the tube so that the toner contacts the D800 photocurable resin. The resin is cured by exposure to light in this position, and the cover glass and tube are removed to form a cylindrical resin with toner embedded in the outermost surface.

This is then cut with an ultrasonic ultramicrotome (Leica UC7) at a cutting speed of 0.6 mm/s to just the length of the toner radius (such as 3.5 microns if the weight-average particle diameter (D4) is 7.0 microns) from the outermost surface of the cylindrical resin, exposing the center of the toner in cross-section.

This is then cut to a film thickness of 100 nm to prepare a thin sample of the toner cross-section. Cross-sections of the center of the toner can be obtained by cutting by these methods.

The resulting thin sample is dyed for 15 minutes in a 500 Pa ruthenium tetroxide (RuO₄) gas atmosphere using an electron vacuum stainer (filgen, VSC4R1H). TEM images of the toner are obtained at an acceleration voltage of 200 kV with a transmission electron microscope (TEM) (JEOL JEM2800).

Images are obtained with a TEM probe size of 1 nm and an image size of 1024×1024 pixels.

The core and shell layer of the toner particle are observed based on contrast in the TEM image. The contrast between light and dark differs according to the material, but the part that appears with a different contrast from the core is considered the shell layer.

Image J image (available from https://imagej.nih.gov/ij) is used as the image analysis software for measuring the thickness of the shell layer as described below.

In 10 randomly selected TEM images of each toner, the toner cross-section is divided into 16 equal parts centered on the intersection of the long axis L of the toner cross-section and an axis 1.90 passing perpendicularly through the center of the long axis L. The distance from the surface of the core to the surface of the shell layer is measured on 16 straight lines extending from the center to the surface of the toner. The arithmetic mean of all the measured values from the 10 toner cross-sections is given as the thickness of the shell layer.

The method for measuring the coverage of the core particle by the shell layer is explained.

The coverage of the core particle by the shell layer is calculated from cross-sectional observation when measuring the thickness of the shell layer. The peripheral length (L) of the core is calculated first. The length (Ls) of the part of the core surface having a shell layer is measured next, and the coverage of the toner by the shell layer is calculated by the formula below. The arithmetic mean value of the coverage calculated from TEM images of 10 toner cross-sections is given as the shell layer coverage.

Coverage ratio of core particle by shell layer (%)=(Ls)/(L)×100

Coverage of Shell Layer by Organosilicon Polymer Particle

The coverage of the shell layer of the toner particle by the organosilicon polymer particle is measured from cross-sectional images of the toner obtained with a transmission electron microscope in the methods for measuring the thickness and coverage of the shell layer above.

In TEM images of each toner, the length (Lc) of the contact between the shell layer and the organosilicon polymer particle is measured. The length (Ls) of the part of the core surface having a shell layer is measured, and the coverage of the shell layer by the organosilicon polymer particle surface is calculated by the formula below.

The arithmetic mean value of the coverage in 10 randomly selected TEM images of toner cross-sections is given as the coverage of the shell layer by the organosilicon polymer particle.

Coverage ratio of shell layer by organosilicon polymer particle (%) (Lc)/(Ls)×100

When the toner contains a silicon-containing substance other than the organosilicon polymer particle, each particle of the external additives is subjected to EDS analysis in toner observation, and the analyzed particle is judged to be an organosilicon polymer particle or not based on the presence or absence of a Si element peak.

EDS analysis is as described above.

Method for Measuring Fixing Index of Organosilicon Polymer Particle

To assess the fixed state of the organosilicon polymer particle, the toner is brought into contact with a substrate and the amount of movement of the organosilicon polymer particle is evaluated. To simulate the surface layer of a photosensitive member, a substrate using polycarbonate resin as a surface layer material is used. Specifically, bisphenol Z-type polycarbonate resin (product name: lupilon Z-400, Mitsubishi Engineering-Plastics Corp., viscosity-average molecular weight (Mv) 40,000) is dissolved in toluene to a concentration of 10 mass % to obtain a coating solution.

This coating solution is coated on a 50 micron-thick aluminum sheet with a #50 Mayer rod to form a film coat. This film coat is dried for 10 minutes at 100° C. to prepare a sheet comprising a polycarbonate resin layer (film thickness 10 microns) on an aluminum sheet. This sheet is held with a substrate holder. The substrate is a square with a side of 3 mm.

The measurement steps are explained below separated into a step of disposing the toner on the substrate, a step of removing the toner from the substrate, and a step of quantifying the adhesion amount of the organosilicon polymer particle supplied to the substrate.

Step of Disposing Toner on Substrate

The toner is contained in a soft porous material (hereunder called the “toner carrier”), and the toner carrier is brought into contact with the substrate. The method of containing the toner in the toner carrier is to dip and remove the toner carrier five times in a container containing a sufficient amount of toner, and then confirm visually that the surface of the toner carrier is not visible because it is covered with the toner. A Marusan Industries sponge (product name: White Wiper) is used as the toner carrier.

The toner carrier containing the toner is fixed to the end of a load cell that itself is fixed to a stage that moves in the perpendicular direction relative to the contact surface of the substrate, so that the toner carrier containing the toner can be brought into contact with the substrate as the load is measured. Contact between the toner carrier containing the toner and the substrate is accomplished by 5 repetitions of a step that consists in moving the stage to press the toner carrier containing the toner against the substrate until the load cell displays 10 N and then separating the two.

Step of Removing Toner from Substrate

Once the toner carrier containing the toner has been brought into contact with the substrate, an elastomer suction port with an inner diameter of 5 mm connected to the nozzle tip of a vacuum cleaner is brought near to the substrate perpendicular to the toner placement surface, and the toner adhering to the substrate is removed. The degree of toner residue is confirmed visually as the toner is removed. The distance between the substrate and the end of the suction port is 1 mm, the suction time is 3 seconds, and the suction pressure is 6 kPa.

Step of Quantifying Adhering Amount of Organosilicon Polymer Particle Supplied to Substrate

Scanning electron microscope observation and image measurement are used to quantify the amount and shapes of the residual organosilicon polymer particles on the substrate after removal of the toner.

First, the substrate after removal of the toner is sputtered with platinum for 60 seconds at a current of 20 mA to obtain a sample for observation.

Any magnification at which the organosilicon polymer particles can be observed may be selected for scanning electron microscope observation. The particles are observed in backscattered electron images taken using a Hitachi ultra-high-resolution field emission scanning electron microscope (product name: S-4800, Hitachi High Technologies). The observation magnification is 50,000, the acceleration voltage is 10 kV, and the operating distance is 3 mm.

Because the organosilicon polymer particles are represented with high brightness and the substrate with low brightness in the images obtained from observation, the amount of organosilicon polymer particles in the visual field can be quantified by binarization. The binarization conditions are selected appropriately according to the observation equipment and the sputtering conditions. Image J (available from https://imagej.nih.gov/ij/) is used as the image analysis software for binarization.

Only the areas of the organosilicon polymer particles are added up in Image J and divided into the area of the observation field as a whole to determine the area ratio of the organosilicon polymer particles in the observation field. This measurement is performed on 100 binarized images, and the average value is given as the area ratio [A] (unit: area %) of the organosilicon polymer particle on the substrate.

Next, the coverage [B] (unit: area %) of the organosilicon polymer particle on the toner particle is calculated.

The coverage of the organosilicon polymer particle is measured by observation and image measurement using a scanning electron microscope. In the scanning electron microscope observation, the magnification for observing the organosilicon polymer particle is the same as the magnification for observing the organosilicon polymer particle on the substrate. An S-4800 (product name) Hitachi ultra-high-resolution field emission scanning electron microscope is used as the scanning electron microscope.

In measuring the area ratio A and coverage B when the toner contains a fine particle other than the organosilicon polymer particle, each particle of the external additives is subjected to EDS analysis in toner observation, and the presence or absence of silicon element is used to judge whether or not an analyzed particle is an organosilicon polymer particle. The specific operations are the same as those used to determine the number average particle diameter of the primary particles of the organosilicon polymer particle.

The image observation conditions are as follows.

(1) Specimen Preparation

An electroconductive paste is spread in a thin layer on the specimen stub (15 mm×6 mm aluminum specimen stub) and the toner is sprayed onto this. Blowing with air is additionally performed to remove excess toner from the specimen stub and carry out thorough drying. The specimen stub is set in the specimen holder and the specimen stub height is adjusted to 36 mm with the specimen height gauge.

(2) Setting Conditions for Observation with S-4800

The coverage [B] of the organosilicon polymer particle is calculated using images obtained by backscattered electron image observation with the S-4800. Because backscattered electron images have less charge-up than secondary electron images, the coverage [B] of the organosilicon polymer particle can be measured more accurately.

Liquid nitrogen is introduced to the brim of the anti-contamination trap attached to the S-4800 housing and standing for 30 minutes is carried out. The “PC-SEM” of the S-4800 is started and flashing is performed (the FE tip, which is the electron source, is cleaned). The acceleration voltage display area in the control panel on the screen is clicked and the [Flashing] button is pressed to open the flashing execution dialog. A flashing intensity of 2 is confirmed and execution is carried out. The emission current due to flashing is confirmed to be 20 to 40 μA. The specimen holder is inserted in the specimen chamber of the S-4800 housing. [Home] is pressed on the control panel to transfer the specimen holder to the observation position.

The acceleration voltage display area is clicked to open the HV setting dialog and the acceleration voltage is set to [0.8 kV] and the emission current is set to [20 μA]. In the [Base] tab of the operation panel, signal selection is set to [SE], [Upper (U)] and [+BSE] are selected for the SE detector, and the instrument is placed in backscattered electron image observation mode by selecting [L. A. 100] in the selection box to the right of [+BSE].

In the same [Basic] tab of the operations panel, the probe current of the electron optical system conditions block is set to [Normal], the focus mode to [UHR], and the WD to [3.0 mm]. The [ON] button of the acceleration voltage display part of the control panel is pressed to apply acceleration voltage.

(3) Focus Adjustment

The magnification is set to 5,000 (5 k) by dragging within the magnification display part of the control panel. The [COARSE] focus knob is turned on the operations panel, and the aperture alignment is adjusted once the entire visual field has been focused to a certain degree. [Align] is clicked on the control panel to display an alignment dialog, and [Beam] is selected. The STIGMA/ALIGNMENT knobs (X,Y) are turned on the operations panel to move the displayed beam to the center of the concentric circles. [Aperture] is then selected, and the STIGMA/ALIGNMENT knobs (X,Y) are turned one after the other until the movement of the image is stopped or minimized. The aperture dialog is closed, and the device is focused in autofocus. This operation is performed two more times to focus the device.

The magnification is then set to 10,000× (10 k) by dragging within the magnification display part of the control panel with the center of the maximum diameter of the observed toner aligned with the center of the measurement screen.

Adjustment of the aperture alignment is carried out when some degree of focus has been obtained by turning the [COARSE] focus knob on the operation panel. [Align] in the control panel is clicked and the alignment dialog is displayed and [Beam] is selected. The displayed beam is migrated to the center of the concentric circles by turning the STIGMA/ALIGNMENT knobs (X, Y) on the operation panel.

[Aperture] is then selected and the STIGMA/ALIGNMENT knobs (X, Y) are turned one after the other and adjustment is performed so as to stop the motion of the image or minimize the motion. The aperture dialog is closed and focus is performed with the autofocus. The magnification is then set to 50,000× (50 k), focus adjustment is carried out as above using the focus knob and STIGMA/ALIGNMENT knobs, and focus is again performed with the autofocus. This operation is repeated again to achieve focus. Here, the accuracy of measurement of the coverage readily declines when the plane of observation has a large angle of inclination, and for this reason simultaneous focus of the plane of observation as a whole is selected during focus adjustment and the analysis is carried out with selection of the smallest possible surface inclination.

(4) Image Storage

Brightness adjustment is performed using the ABC mode, and a photograph with a size of 640×480 pixels is taken and saved. Analysis is carried out as follows using this image file. One photograph is taken per one toner, and images are obtained for at least 100 or more toner particles.

The observed image is binarized with Image J image analysis software (available from https://imagej.nih.gov/ij/). Following binarization, [Analyze]-[Analyze Particles] is used to extract only the organosilicon polymer particles based on EDS analysis, and determine the coverage (unit: area %) of the organosilicon polymer particle on the toner particle.

This measurement is applied to 100 binarized images, and the average value of the coverage (unit: area %) of the organosilicon polymer particle is given as the coverage [B] of the organosilicon polymer particle. The fixing index of the organosilicon polymer particle is determined by the following formula (1) from the area ratio [A] of organosilicon polymer particles on the substrate and the coverage [B] of the organosilicon polymer particle.

Fixing index=area ratio [A] of organosilicon polymer particles transferred to polycarbonate film/coverage [B] of organosilicon polymer particle on toner particle surface×100 (1)

Method for Measuring Dispersity Evaluation Index of Organosilicon Polymer Particle

The dispersity evaluation indexes for the organosilicon polymer particles at the toner surface are determined using an “S-480” scanning electron microscope. In a visual field enlarged by 10,000λ, observation at an acceleration voltage of 1.0 kV is performed in the same visual field of the toner to which the organosilicon polymer particle has been externally added. The determination is carried out, from the observed image, as described in the following using “Image-Pro Plus 5.1J” (MediaCybernetics) image processing software.

The image is binarized so that only the organosilicon polymer particles are extracted, the number n of organosilicon polymer particles and the center of gravity coordinates relative to all organosilicon polymer particles are calculated, and the distance dn min to the nearest organosilicon polymer particle from each organosilicon polymer particle is calculated. The dispersity is represented by the formula below given “dave” as the average value of the closest distance between organosilicon polymer particles in the image.

Dispersity is determined by the above procedures for 50 randomly observed toners, and the calculated average value is given as the dispersity evaluation index. The smaller the dispersity evaluation index, the better the dispersibility.

When the toner contains a fine particle other than the organosilicon polymer particle, the organosilicon polymer particle is distinguished by the EDS analysis described above.

$$Dispersity Evaluation Index = \sqrt{\frac{{\sum }_{γ}^{n} {( dn min - d ave )}^{2}}{n}} \text{/} d ave \qquad [ Math . 1 ]$$

Method for Measuring Weight-average Particle Diameter (D4) of Toner

The weight-average particle diameter (D4) of the toner is calculated as follows. A precision particle size distribution measurement device operating on the aperture impedance method and equipped with a 100-micron aperture tube (Coulter Counter Multisizer 3 (registered trademark, Beckman Coulter) is used as the measurement unit. The dedicated software (Beckman Coulter Multisizer 3 Version 3.51, Beckman Coulter) included with the unit is used for setting the measurement conditions and analyzing the measurement data. Measurement is performed with 25,000 effective measurement channels.

The aqueous electrolytic solution used for measurement is a solution of special-grade sodium chloride dissolved in deionized water to a concentration of about 1 mass %, such as “Isoton II” (Beckman Coulter).

The dedicated software is configured as follows prior to measurement and analysis.

On the “Change Standard Operating Measurement Method (SOMME)” screen of the dedicated software, the total count number in control mode is set to 50,000 particles, the number of measurements to 1, and the Kd value to a value obtained using “Standard particles 10.0 μm” (Beckman Coulter). The threshold value and noise level are set automatically by pressing the “Threshold/Noise level measurement” button. The current is set to 1,600 μA, the gain to 2 and the electrolytic solution to Isoton II, and a check is entered for “Aperture flush after measurement”.

On the “Conversion setting from pulse to particle diameter” screen of the dedicated software, the bin interval is set to the logarithmic particle diameter and the particle diameter bins to 256 particle diameter bins, with a particle diameter range from 2 microns to 60 microns.

The specific measurement methods are as follows.

(1) 200 ml of the above aqueous electrolytic solution is placed in a 250 ml glass round-bottomed beaker dedicated to the Multisizer 3, the this is set in the sample stand and stirred counter-clockwise at a rate of 24 rotations per second of the stirrer rod. Contamination and air bubbles in the aperture tube are removed by the “Aperture flush” function of the dedicated software.

(2) 30 ml of the above aqueous electrolytic solution is placed in a 100 ml glass flat-bottomed beaker, and about 0.3 ml of a diluted solution of “Contaminon N” (a 10 mass % aqueous solution of a pH 7 neutral detergent for cleaning precision measurement instruments, comprising a nonionic surfactant, an anionic surfactant and an organic builder, manufactured by Wako Pure Chemical Industries) diluted 3 times by mass with deionized water is added thereto as a dispersant.

(3) An ultrasound disperser with an electrical output of 120 W equipped with two built-in oscillators with an oscillation frequency of 50 kHz disposed so that their phases are displaced by 180 degrees (Ultrasonic Dispersion System Tetra 150, Nikkaki Bios) is prepared. About 3.3 liters of deionized water is placed in the water tank of the ultrasound disperser, and about 2 ml of Contaminon N is added to the water tank.

(4) The beaker of (2) above is set in the beaker fixing hole of the ultrasound disperser, and the ultrasound disperser is operated. The vertical position of the beaker is adjusted so as to maximize the resonance state of the surface of the aqueous electrolytic solution in the beaker.

(5) About 10 mg of toner is added bit by bit and dispersed in the aqueous electrolytic solution in the beaker of (4) above as the aqueous electrolytic solution is exposed to ultrasound. Ultrasound dispersion is then continued for another 60 seconds. The water temperature of the water tank is adjusted appropriately so as to be 10° C. to 40° C. during ultrasound dispersion.

(6) The aqueous electrolytic solution of (5) above containing the dispersed toner is dripped with a pipette into the round-bottomed beaker of (1) above set in the sample stand to adjust the measurement concentration to 5%. Measurement is then performed until the number of measured particles reaches 50,000.

(7) The measurement data is analyzed with the above dedicated software included with the apparatus to calculate the weight-average particle diameter (D4). The weight-average particle diameter (D4) is the “average diameter” on the [Analysis/volumetric statistical value (arithmetic average)] screen when Graph/Vol % is set on the dedicated software.

### EXAMPLES

The present invention is described in greater detail in the following using examples and comparative examples, but the present invention is in no way limited to or by this. The number of parts in the examples are based on mass unless otherwise specified.

Manufacturing Example of Organosilicon Polymer Particle 1

### First Step

360 parts of water was introduced into a reaction vessel fitted with a thermometer and a stirrer, and 13 parts of hydrochloric acid having a concentration of 5.0 mass % was added to provide a uniform solution. While stirring this at a temperature of 25° C., 122 parts of methyltrimethoxysilane and 15 parts of tetramethoxysilane were added, stirring was performed for 5 hours, and filtration was carried out to obtain a transparent reaction solution containing a silanol compound and partial condensate thereof.

### Second Step

440 parts of water was introduced into a reaction vessel fitted with a thermometer, stirrer, and dropwise addition apparatus, and 17 parts of aqueous ammonia having a concentration of 10.0 mass % was added to provide a uniform solution. While stirring this at a temperature of 35° C., 100 parts of the reaction solution obtained in the first step was added dropwise over 0.50 hour, and stirring was performed for 6 hours to obtain a suspension. The resulting suspension was processed with a centrifugal separator and the fine particles were sedimented and withdrawn and were dried for 24 hours with a dryer at a temperature of 200° C. to obtain organosilicon polymer particle 1.

The resulting organosilicon polymer particle 1 had a number average particle diameter of 100 nm of the primary particles, the area ratio of T3 unit structures was 0.89, and the Wa was 5.48 eV.

Manufacturing Example of Organosilicon Polymer Particle 2

100 parts of the organosilicon polymer particle 1 were surface treated with 15 parts of hexamethyl disilazane to obtain an organosilicon polymer particle 2. The physical properties are shown in Table 1.

Manufacturing Example of Organosilicon Polymer Particle 3

100 parts of the organosilicon polymer particle 1 were surface treated with 10 parts of gamma-aminopropyl triethoxysilane to obtain an organosilicon polymer particle 3. The physical properties are shown in Table 1.

Manufacturing Examples of Organosilicon Polymer Particles 4 to 11

Organosilicon polymer particles 4 to 11 were obtained as in the manufacturing example of the organosilicon polymer particle 1 except that the silane compounds and manufacturing conditions were changed as shown in Table 1. The physical properties of the resulting organosilicon polymer particles 4 to 11 are shown in Table 1.

Manufacturing Example of Organosilicon Polymer Particle 12

100 pans of the organosilicon polymer particle 1 were surface treated with 25 parts of hexamethyl disilazane to obtain an organosilicon polymer particle 12. The physical properties are shown in Table 1.

TABLE 1

| | First step | | | | | | | | |
|---|---|---|---|---|---|---|---|---|---|
| Organosilicon | | Hydrochloric | Reaction | | | | | | |
| polymer | Water | acid | temperature | Silane compound A | | Silane compound B | | Silane compound C | |
| particle No. | Parts | Parts | ° C. | Name | Parts | Name | Parts | Name | Parts |
| 1 | 360 | 13 | 25 | Methyl | 122 | Tetramethoxysilane | 15 | | |
| | | | | trimethoxysilane | | | | | |
| 2 | 360 | 13 | 25 | Methyl | 122 | Tetramethoxysilane | 15 | | |
| | | | | trimethoxysilane | | | | | |
| 3 | 360 | 13 | 25 | Methyl | 122 | Tetramethoxysilane | 15 | | |
| | | | | trimethoxysilane | | | | | |
| 4 | 360 | 13 | 25 | Methyl | 122 | Tetramethoxysilane | 15 | | |
| | | | | trimethoxysilane | | | | | |
| 5 | 360 | 13 | 25 | Methyl | 122 | Tetramethoxysilane | 15 | | |
| | | | | trimethoxysilane | | | | | |
| 6 | 360 | 13 | 25 | Methyl | 122 | Tetramethoxysilane | 15 | | |
| | | | | trimethoxysilane | | | | | |
| 7 | 360 | 13 | 25 | Methyl | 122 | Tetramethoxysilane | 15 | | |
| | | | | trimethoxysilane | | | | | |
| 8 | 360 | 13 | 25 | Methyl | 68 | Dimethyl | 48 | Trimethyl | 10 |
| | | | | trimethoxysilane | | dimethoxysilane | | monomethoxysilan | |
| 9 | 360 | 13 | 25 | Methyl | 61 | Dimethyl | 54 | Trimethyl | 10 |
| | | | | trimethoxysilane | | dimethoxysilane | | monomethoxysilan | |
| 10 | 360 | 13 | 25 | Methyl | 122 | Tetramethoxysilane | 15 | Trimethyl | 10 |
| | | | | trimethoxysilane | | | | monomethoxysilan | |
| 11 | 360 | 13 | 25 | Methyl | 43 | Dimethyl | 64 | Trimethyl | 15 |
| | | | | trimethoxysilane | | dimethoxysilane | | monomethoxysilan | |
| 12 | 360 | 13 | 25 | Methyl | 122 | Tetramethoxysilane | 15 | | |
| | | | | trimethoxysilane | | | | | |

| | Second step | | | | | |
|---|---|---|---|---|---|---|
| | Reaction | | | | | |
| | solution | | | Reaction | | Surface |
| Organosilicon | obtained in | | Ammonia | initiation | Dripping | treatment |
| polymer | first step | Water | water | temperature | time | step |
| particle No. | Parts | Parts | Parts | ° C. | Hours | Name |
| 1 | 100 | 440 | 17 | 35 | 0.50 | |
| 2 | 100 | 440 | 17 | 35 | 0.50 | Hexamethyl |
| | | | | | | disilazane |
| 3 | 100 | 440 | 17 | 35 | 0.50 | Gamma- |
| | | | | | | aminopropyl |
| 4 | 100 | 440 | 20 | 35 | 1.27 | |
| 5 | 100 | 440 | 20 | 35 | 3.00 | |
| 6 | 100 | 440 | 20 | 35 | 0.23 | |
| 7 | 100 | 440 | 20 | 35 | 0.18 | |
| 8 | 100 | 440 | 18 | 35 | 0.50 | |
| 9 | 100 | 440 | 18 | 35 | 0.50 | |
| 10 | 100 | 440 | 18 | 35 | 0.31 | |
| 11 | 100 | 440 | 18 | 35 | 0.35 | |
| 12 | 100 | 440 | 17 | 35 | 0.50 | Hexamethyl |
| | | | | | | disilazane |

| | Surface treatment step | | Number | | |
|---|---|---|---|---|---|
| | | Surface | average | | |
| Organosilicon | Organosilicon | treatment | particle | | Area ratio |
| polymer | polymer | agent | diameter | Work | of T3 unit |
| particle No. | Parts | Parts | nm | function | structures |
| 1 | | | 100 | 5.48 | 0.89 |
| 2 | 100 | 15 | 100 | 5.71 | 0.89 |
| 3 | 100 | 10 | 100 | 5.34 | 0.89 |
| 4 | | | 40 | 5.51 | 0.86 |
| 5 | | | 15 | 5.53 | 0.85 |
| 6 | | | 320 | 5.47 | 0.91 |
| 7 | | | 530 | 5.46 | 0.92 |
| 8 | | | 100 | 5.55 | 0.51 |
| 9 | | | 100 | 5.50 | 0.46 |
| 10 | | | 220 | 5.47 | 0.91 |
| 11 | | | 100 | 5.46 | 0.35 |
| 12 | 100 | 25 | 100 | 5.79 | 0.89 |

In the table, the work function is given in units of eV.

Compositions of Compounds Used in Shell Layers 1 to 7

The composition of the compounds used in the shell layers 1 to 7 are shown in Table 2. The methods for forming the shell are described below.

Manufacturing Example of Compound Used in Shell Layer 5

A reaction vessel containing 790 parts of deionized water and 30 parts of a cationic surfactant (Kao Corp. “Quartamin 24P”, 25 mass % aqueous solution of lauryl trimethyl ammonium chloride) was heated to 80° C. Next, a mixture of 100 parts of methyl methacrylate, 30 parts of n-butyl acrylate and 20 parts of (3-acrylamidopropyl) trimethyl ammonium chloride (quaternary ammonium salt) and a solution of 0.5 parts of potassium persulfate dissolved in 30 parts of deionized water were each dripped into the flask over the course of 5 hours.

The flask contents were then polymerized for 2 hours with the temperature maintained at 80° C. After completion of polymerization, the reaction solution was cooled to room temperature, and the concentration was adjusted to obtain a water-based dispersion S1 of a compound for use in the shell layer 5 with a solids concentration of 50 mass % and a weight-average particle diameter (D4) of 50 nm.

Manufacturing Example of Compound Used in Shell Layer 6

100 parts of a methyl methacrylate macromonomer (Toagosei Co., Ltd. “AA-6”) were added and dispersed in an aqueous solution of 3.0 parts of the dispersant (surfactant) Neogen RK (Daiichi Kogyo) dissolved in 50 parts of deionized water. This was stirred slowly for 10 minutes as an aqueous solution of 0.3 parts of potassium persulfate dissolved in 10 parts of deionized water was added. After nitrogen purging, this was emulsion polymerized for 6 hours at 70° C.

After completion of polymerization, the reaction solution was cooled to room temperature, and deionized water was added to obtain a water-based dispersion S2 of a compound for use in the shell layer 6 with a solids concentration of 50 mass % and a weight-average particle diameter (D4) of 40 nm.

Manufacturing Example of Compound Used in Shell Layer 7

Terephthalic acid: 30 moles

Fumaric acid: 70 moles

Polyoxypropylene (2.2)-2,2-bis(4-hydroxyphenyl) propane: 95 moles

Polyoxyethylene (2.2)-2,2-bis(4-hydroxyphenyl) propane: 5 moles

These materials were placed in a 2-liter glass 4-necked flask, a thermometer, a stainless steel stirring rod, a flow-down condenser and a nitrogen introduction pipe were attached, and the mixture was reacted for 22 hours at 230° C. in a nitrogen flow in a mantle heater to obtain a polyester resin A.

Polyester resin A: 100.0 parts

Nonionic surfactant (Noigen XL-160, Daiichi Kogyo, cloud point 98° C.): 2.0 parts

Dimethyl aminoethanol (Kishida Chemical): 7.5 parts

These materials were placed in a 500 ml beaker and mixed for 120 minutes at 95.0° C. under stirring with a stirrer at 200 r/min. The temperature was then maintained as 200.0 parts of deionized water heated to 95.0° C. were dripped in under stirring with a stirrer at 200 r/min over the course of 2 hours.

The resulting dispersion was passed through a 105-micron metal mesh to remove coarse particle components and obtain a water-based dispersion S3 of a compound for use in the shell layer 7. Deionized water was added to obtain a solids concentration of 50 mass %.

TABLE 2

| | Monomer | | | | | |
|---|---|---|---|---|---|---|
| | Butyl | Methylol | Methylolized | 2-vinyl-2- | Quaternary | Methyl |
| | acrylate | melamine | urea | oxazoline | ammonium salt | methacrylate |
| | Parts | Parts | Parts | Parts | Parts | Parts |
| Shell layer 1 | | 100 | | | | |
| Shell layer 2 | | 100 | | | | |
| Shell layer 3 | | | | 90 | | 10 |
| Shell layer 4 | | | 100 | | | |
| Shell layer 5 | 30 | | | | 20 | 100 |
| Shell layer 6 | | | | | | 100 |

| | |
|---|---|
| Shell layer 7 | See Description |

Shell layer 1: Showa Denko “Mirben (registered trademark) resin SM-607”

Shell layer 2: Showa Denko “Mirben (registered trademark) resin SM-300”

Shell layer 3: Aqueous solution of oxazoline-containing polymer, Nippon Shokubai “EPOCROS WS-300”, monomer composition: methyl methacrylate/2-vinyl-2-oxazoline

Shell layer 4: Showa Denko “Mirben (registered trademark) resin SUM-100”

Shell layer 6: Polymethyl methacrylate (Toagosei “AA-6”)

Manufacturing Example of Polyester Resin Composition 1

Bisphenol A propylene oxide adduct (2,2-mol adduct) 95.0 moles

Bisphenol A ethylene oxide adduct (2,2-mol adduct) 10.0 moles

Terephthalic acid 90.0 moles

Adipic acid 5.0 moles

This polyester monomer mixture was placed in a 5-liter autoclave together with dibutyl tin oxide in the amount of 0.2 mass % of the total monomers, and a reflux cooler, a moisture separator, an N₂ gas introduction pipe, a thermometer and a stirring device were attached. N₂ gas was introduced into the autoclave as a polycondensation reaction was performed at 230° C. The reaction time was adjusted so as to achieve the desired Tg, and the contents were removed from the vessel after completion of the reaction and cooled and pulverized to obtain a polyester resin composition 1. The polyester resin composition 1 had a Tg of 49° C.

Manufacturing Example of Core Particle 1

The manufacturing example of the core particle 1 is explained.

### Manufacturing Example of Core Particle 1

Polyester resin composition 1: 100 parts

C.I. pigment blue 15:3 (copper phthalocyanine): 5 parts

Ester wax (stearyl sebacate: melting point 72° C.): 15 parts

Fischer-Tropsch wax (Sasol Co. C105, melting point 105° C.): 2 parts

Charge control agent (P-51, Orient Chemical Industry): 1.2 parts

These materials were pre-mixed in an FM Mixer (Nippon Coke and Engineering, FM10C), and then melt kneaded with a twin-screw extruder (product name: PCM-30, Ikegai) with the temperature adjusted so that the temperature of the melted product at the discharge port was 140° C.

The kneaded product was cooled, coarsely pulverized with a hammer mill, and then finely pulverized with a pulverizing device (product name: Turbo Mill T250, Turbo Industries). The resulting fine powder was classified with a multi-division classifier using the Coanda effect to obtain a core particle 1 with a weight-average particle diameter (D4) of 6.8 microns.

Manufacturing Example of Toner Particle 1

A reaction vessel containing 300.0 parts of deionized water was maintained at 30° C., and dilute hydrochloric acid was added to adjust the pH of the aqueous medium to 4.0. After pH adjustment, 100.0 parts of the core particle 1 obtained above were added to prepare a slurry of the core particle 1.

Next, 1.25 parts of a shell material (aqueous solution of hexamethylol melamine initial polymer with solids concentration of 80 mass %, Showa Denko “Mirben (registered trademark) resin SM-607”) were added to the flask. The temperature was raised to 75° C. at a rate of 1.0° C./minute and maintained for 2 hours to form a shell layer on the surface of the core particles.

This was cooled to room temperature, and filtered, water washed and dried to obtain a toner particle 1 with a weight-average particle diameter (D4) of 6.8 microns having a core-shell structure.

Manufacturing Example of Toner 1

Using an FM Mixer (Nippon Coke and Engineering, FM10C), the organosilicon polymer particle 1 and a hydrophobic silica fine particle were added to the toner particle 1.

With the water temperature inside the jacket of the FM mixer maintained at a stable temperature of 25° C. PC, 1.5 parts of the organosilicon polymer particle 1 and 0.6 parts of a hydrophobic silica particle (Nippon Aerosil “AEROSIL (registered trademark) RA-200H”, dry silica particle surface treated with trimethylsilyl groups and amino groups, number average primary particle diameter 12 nm) were added to 100 parts of the toner particle 1. Mixing was initiated at a peripheral speed of 28 m/sec of the rotary blade, and the water temperature and flow rate inside the jacket were controlled to maintain a stable temperature of 25° C.±1° C. inside the tank as the contents were mixed for 4 minutes, and then sieved with a 75-micron mesh to obtain a toner 1.

Table 3 shows the types and added amounts of the toner particle, core and shell layer used to prepare the toner 1, the external additive mixing conditions, and the content of the organosilicon polymer particle in the toner. Table 4 shows the work function analyzed from the toner 1, the thickness and coverage of the shell, the coverage of the organosilicon polymer particle on the shell, and the fixing index and dispersity evaluation index of the organosilicon polymer particle. The physical properties of the organosilicon polymer particle as analyzed from the toners were the same as the values shown in Table 1.

TABLE 3

| | | | | | | | External addition step | | | |
|---|---|---|---|---|---|---|---|---|---|---|
| | | | | Added | | | External | | Hydrophobic | Content of |
| | | | | amount | | | additive | | silica | organosilicon |
| | Toner | | Shell | of shell | | | | Added | Added | polymer particle |
| Toner | particle | Core | layer | Parts | Wa | Wb | Type | parts | parts | in toner (mass %) |
| Toner 1 | Toner | Core | Shell | 1.0 | 5.48 | 5.00 | Organosilicon | 1.5 | 0.6 | 1.47% |
| | particle 1 | particle 1 | layer 1 | | | | polymer 1 | | | |
| Toner 2 | Toner | Core | Shell | 1.0 | 5.71 | 5.00 | Organosilicon | 1.5 | 0.6 | 1.47% |
| | particle 1 | particle 1 | layer 1 | | | | polymer 2 | | | |
| Toner 3 | Toner | Core | Shell | 1.0 | 5.34 | 5.31 | Organosilicon | 1.5 | 0.6 | 1.47% |
| | particle 2 | particle 1 | layer 2 | | | | polymer 3 | | | |
| Toner 4 | Toner | Core | Shell | 0.4 | 5.48 | 5.00 | Organosilicon | 1.5 | 0.6 | 1.47% |
| | particle 1 | particle 1 | layer 1 | | | | polymer 1 | | | |
| Toner 5 | Toner | Core | Shell | 0.3 | 5.48 | 5.00 | Organosilicon | 1.5 | 0.6 | 1.47% |
| | particle 2 | particle 1 | layer 1 | | | | polymer 1 | | | |
| Toner 6 | Toner | Core | Shell | 6.1 | 5.48 | 5.00 | Organosilicon | 1.5 | 0.6 | 1.47% |
| | particle 3 | particle 1 | layer 1 | | | | polymer 1 | | | |
| Toner 7 | Toner | Core | Shell | 7.2 | 5.48 | 5.00 | Organosilicon | 1.5 | 0.6 | 1.47% |
| | particle 4 | particle 1 | layer 1 | | | | polymer 1 | | | |
| Toner 8 | Toner | Core | Shell | 1.0 | 5.51 | 5.00 | Organosilicon | 0.6 | 0.6 | 0.59% |
| | particle 1 | particle 1 | layer 1 | | | | polymer 4 | | | |
| Toner 9 | Toner | Core | Shell | 1.0 | 5.53 | 5.00 | Organosilicon | 0.23 | 0.6 | 0.23% |
| | particle 1 | particle 1 | layer 1 | | | | polymer 5 | | | |
| Toner 10 | Toner | Core | Shell | 1.0 | 5.47 | 5.00 | Organosilicon | 4.6 | 0.6 | 4.37% |
| | particle 1 | particle 1 | layer 1 | | | | polymer 6 | | | |
| Toner 11 | Toner | Core | Shell | 1.0 | 5.46 | 5.00 | Organosilicon | 7.9 | 0.6 | 7.28% |
| | particle 1 | particle 1 | layer 1 | | | | polymer 7 | | | |
| Toner 12 | Toner | Core | Shell | 1.0 | 5.48 | 5.00 | Organosilicon | 0.15 | 0.6 | 0.15% |
| | particle 1 | particle 1 | layer 1 | | | | polymer 1 | | | |
| Toner 13 | Toner | Core | Shell | 1.0 | 5.48 | 5.00 | Organosilicon | 0.08 | 0.6 | 0.08% |
| | particle 1 | particle 1 | layer 1 | | | | polymer 1 | | | |
| Toner 14 | Toner | Core | Shell | 1.0 | 5.48 | 5.00 | Organosilicon | 7.8 | 0.6 | 7.20% |
| | particle 1 | particle 1 | layer 1 | | | | polymer 1 | | | |
| Toner 15 | Toner | Core | Shell | 1.0 | 5.48 | 5.00 | Organosilicon | 8.5 | 0.6 | 7.79% |
| | particle 1 | particle 1 | layer 1 | | | | polymer 1 | | | |
| Toner 16 | Toner | Core | Shell | 1.0 | 5.48 | 5.26 | Organosilicon | 1.5 | 0.6 | 1.47% |
| | particle 5 | particle 1 | layer 3 | | | | polymer 1 | | | |
| Toner 17 | Toner | Core | Shell | 1.3 | 5.48 | 5.10 | Organosilicon | 1.5 | 0.6 | 1.47% |
| | particle 6 | particle 1 | layer 4 | | | | polymer 1 | | | |
| Toner 18 | Toner | Core | Shell | 1.0 | 5.48 | 5.19 | Organosilicon | 1.5 | 0.6 | 1.47% |
| | particle 7 | particle 1 | layer 5 | | | | polymer 1 | | | |
| Toner 19 | Toner | Core | Shell | 1.0 | 5.55 | 5.00 | Organosilicon | 1.5 | 0.6 | 1.47% |
| | particle 1 | particle 1 | layer 1 | | | | polymer 8 | | | |
| Toner 20 | Toner | Core | Shell | 1.0 | 5.56 | 5.00 | Organosilicon | 1.5 | 0.6 | 1.47% |
| | particle 1 | particle 1 | layer 1 | | | | polymer 9 | | | |
| Toner 21 | Toner | Core | Shell | 1.0 | 5.71 | 5.10 | Organosilicon | 1.5 | 0.6 | 1.47% |
| | particle 6 | particle 1 | layer 4 | | | | polymer 2 | | | |
| Toner 22 | Toner | Core | Shell | 1.0 | 5.48 | 5.31 | Organosilicon | 1.5 | 0.6 | 1.47% |
| | particle 2 | particle 1 | layer 2 | | | | polymer 1 | | | |
| Toner 23 | Toner | Core | Shell | 0.0 | 5.48 | 5.00 | Organosilicon | 1.5 | 0.6 | 1.47% |
| | particle 8 | particle 1 | layer 1 | | | | polymer 1 | | | |
| Toner 24 | Toner | Core | Shell | 1.0 | 5.47 | 5.00 | Organosilicon | 1.5 | 0.6 | 1.47% |
| | particle 1 | particle 1 | layer 1 | | | | polymer 10 | | | |
| Comparative | Toner | Core | Shell | 1.0 | 5.48 | 5.19 | Organosilicon | 1.5 | 0.6 | 1.47% |
| Toner 1 | particle 9 | particle 1 | layer 6 | | | | polymer 1 | | | |
| Comparative | Toner | Core | Shell | 1.0 | 5.46 | 5.66 | Organosilicon | 2.4 | 0.6 | 2.33% |
| Toner 2 | particle 10 | particle 1 | layer 7 | | | | polymer 11 | | | |
| Comparative | Toner | Core | Shell | 1.0 | 5.28 | 5.10 | Large silica | 1.5 | 0.6 | 1.47% |
| Toner 3 | particle 5 | particle 1 | layer 3 | | | | | | | |
| Comparative | Toner | Core | Shell | 1.0 | 5.77 | 5.00 | Organosilicon | 1.5 | 0.6 | 1.47% |
| Toner 4 | particle 1 | particle 1 | layer 1 | | | | polymer 12 | | | |

Although no organosilicon polymer particle was used in the Comparative Toner 3, the work function of the large silica used is shown as Wa in Tables 3 and 4.

TABLE 4

| | | | | Coverage ratio | | |
|---|---|---|---|---|---|---|
| | | | | of shell by | | |
| | | Shell | Shell | organosilicon | | Dispersity |
| | | thickness | coverage | polymer particle | Fixing | evaluation |
| Toner | Wa − Wb | nm | % | % | index | index |
| Toner 1 | 0.48 | 15 | 84% | 38% | 4.1 | 1.2 |
| Toner 2 | 0.71 | 15 | 86% | 43% | 3.9 | 1.0 |
| Toner 3 | 0.03 | 17 | 81% | 32% | 4.3 | 1.6 |
| Toner 4 | 0.48 | 13 | 33% | 41% | 4.4 | 1.9 |
| Toner 5 | 0.48 | 11 | 24% | 44% | 4.5 | 2.1 |
| Toner 6 | 0.48 | 225 | 89% | 38% | 4.0 | 1.1 |
| Toner 7 | 0.48 | 263 | 91% | 38% | 3.9 | 0.9 |
| Toner 8 | 0.51 | 15 | 84% | 39% | 4.0 | 1.4 |
| Toner 9 | 0.53 | 15 | 84% | 38% | 3.9 | 1.7 |
| Toner 10 | 0.47 | 15 | 84% | 38% | 4.3 | 1.0 |
| Toner 11 | 0.46 | 15 | 84% | 38% | 4.6 | 0.9 |
| Toner 12 | 0.48 | 15 | 84% | 11% | 4.0 | 1.4 |
| Toner 13 | 0.48 | 15 | 84% | 6% | 4.0 | 1.4 |
| Toner 14 | 0.48 | 15 | 84% | 73% | 4.4 | 0.9 |
| Toner 15 | 0.48 | 15 | 84% | 78% | 4.6 | 0.8 |
| Toner 16 | 0.22 | 17 | 82% | 34% | 3.9 | 1.3 |
| Toner 17 | 0.38 | 14 | 85% | 33% | 4.1 | 1.2 |
| Toner 18 | 0.29 | 25 | 76% | 36% | 4.0 | 1.2 |
| Toner 19 | 0.55 | 15 | 84% | 42% | 4.5 | 1.3 |
| Toner 20 | 0.56 | 15 | 84% | 43% | 4.6 | 1.8 |
| Toner 21 | 0.61 | 15 | 83% | 40% | 4.0 | 1.1 |
| Toner 22 | 0.17 | 15 | 82% | 33% | 4.2 | 1.3 |
| Toner 23 | 0.48 | 13 | 53% | 41% | 4.3 | 1.7 |
| Toner 24 | 0.47 | 15 | 84% | 38% | 4.3 | 1.2 |
| Comparative | 0.32 | 14 | 93% | 31% | 4.4 | 1.3 |
| Toner 1 | | | | | | |
| Comparative | −0.2 | 17 | 81% | 32% | 4.4 | 1.3 |
| Toner 2 | | | | | | |
| Comparative | 0.18 | 14 | 86% | 38% | 4.1 | 1.2 |
| Toner 3 | | | | | | |
| Comparative | 0.77 | 15 | 86% | 43% | 3.9 | 1.0 |
| Toner 4 | | | | | | |

In the table, the shell coverage is the coverage of the core particle by the shell layer.

Manufacturing Examples of Toners 2 to 17 and 19 to 24 and Comparative Toners 1 to 4

Toners 2 to 17 and 19 to 24 and comparative toners 1 to 4 were obtained as in the manufacturing example of the toner 1 except that the core particles, the types and added amounts of the shell layers, and the types and added amounts of the organosilicon polymer particles were as shown in Table 3. The physical properties are shown in Table 4. The physical properties of the organosilicon polymer particle as analyzed from the toner 1 were the same as the values shown in Table 1.

Silica having the following physical properties was prepared as the large silica used in the Comparative Toner 3.

Silica fine particle prepared by sol-gel method
number average particle diameter of primary particles: 100 nm
ratio of peak area derived from silicon having T3 unit structure: 0%

Manufacturing Example of Toner 18

Manufacturing Example of Toner Particle 7

Forming Shell Layer

A reaction vessel containing 300.0 parts of deionized water was maintained at 30° C. Sodium hydroxide or dilute hydrochloride acid was then added inside the flask to adjust the pH of the flask contents to 7.

2.0 parts of the shell material S1 were then added inside the flask. 100 parts of the core particle 1 were then added, and the contents were stirred for 1 hour at a rotational speed of 200 rpm. 300 parts of deionized water were then added inside the flask, and the temperature was raised to 70° C. at a rate of 1° C./minute under stirring at 100 rpm, after which the temperature was maintained and stirring was continued for 2 hours.

The toner particle dispersion was then cooled to room temperature (about 25° C.). After cooling to room temperature, this was filtered, water washed and dried to obtain a toner particle 7 having a core-shell structure.

A toner 18 was obtained as in the manufacturing example of the toner 1 and under the same conditions except that the toner particle 7 was used and the type and added amount of the external additive were as shown in Table 3. The physical properties of the toner 18 are shown in Table 4.

### Example 1

A modified LBP-7700C commercial laser printer (Canon) was used as the image-forming apparatus together with a modified 323 cyan toner cartridge (Canon) as the commercial process cartridge. The commercial toner was removed from the cartridge, which was then cleaned by air blowing and filled with 150 g of the toner of the invention.

The laser printer was modified so that the potential was opposite to normal in each process for purposes of evaluating a positive-charge toner. The process cartridge was modified so that the members including the photosensitive drum and charging roller were charged to the opposite charge from normal.

Durability Evaluation (Image Density)

The modified LBP-7700C, the modified cyan cartridge filled with the toner for evaluation, and evaluation paper (A4 color laser copy paper, (Canon, 80 g/m²)) were let for 24 hours in a high-temperature high-humidity (30° C./80% RH) environment.

An image forming test was then performed by printing 15,000 sheets of a horizontal line pattern with image coverage of 1% with the mode set so that the machine was stopped between jobs before starting the next job.

The image density was measured on the 1st sheet and the 15,000th sheet. A 5 mm×5 mm solid black patch image was output, and the image density was measured by measuring reflection density with a Macbeth reflection density meter (Macbeth Co.) using an SPI filter. The results are shown in Table 5.

A: Image density at least 1.40
B: Image density 1.30 to less than 1.40
C: Image density 1.20 to less than 1.30
D: Image density less than 1.20

Evaluating Initial Fogging

The modified LBP-7700C, the modified cyan cartridge filled with the toner for evaluation, and evaluation paper (A4 color laser copy paper, (Canon, 80 g/m²)) were left for 24 hours in a high-temperature high-humidity (30° C./80% RH) environment.

One copy of an image with image coverage of 0% was then output on paper that had been protected by partially covering to prevent printing. The whiteness degree of the parts of the image and the protected area were then measured with a reflectometer equipped with an amber filter (Retlectometer Model TC-6DS, Tokyo Denshoku), and fogging was evaluated based on the difference of whiteness degree between the parts of the image and the protected area. Initial fogging was evaluated based on the following standard, with the results shown in Table 5.

A: Fogging 0.5% or less
B: Fogging more than 0.5% and not more than 1.5%
C: Fogging more than 1.5% and not more than 2.5%
D: Fogging more than 2.5%

Evaluating Vertical Streaks

The modified LBP-7700C, the modified cyan cartridge filled with the toner for evaluation, and evaluation paper (A4 color laser copy paper, (Canon. 80 g/m²)) were left for 24 hours in a low-temperature low-humidity (15° C./10% RH) environment.

1,000 sheets of a horizontal line pattern with image coverage of 1% were then continuously output, after which a solid black image was output, and the occurrence level of vertical streaks was confirmed visually. The results are shown in Table 5.

A: No vertical streaks

B: Vertical streak in one place

C: Vertical streaks in 2 to 4 places

D: Vertical streaks in at least 5 places

Evaluating Low-Temperature Fixability

The modified LBP-7700C was modified so that the fixing temperature of its fixing apparatus can be set as desired. The modified LBP-7700C, the modified cyan cartridge filled with the toner for evaluation, and evaluation paper (A4 color laser copy paper, (Canon, 80 g/m²)) were left for 24 hours in a normal-temperature normal-humidity (25.0° C./60% RH) environment.

The fixing temperature was then raised from 140° C. to 180° C. in 2° C. increments, and the minimum temperature at which white spots occurred was given as the fixing temperature and used to evaluate fixability. The results are shown in Table 5.

A: Fixing temperature less than 150° C.

B: Fixing temperature 150° C. to 158° C.

C: Fixing temperature 160° C. to 168° C.

D: Fixing temperature 170° C. to 180° C.

TABLE 5

| | | Fogging in | | | | | | | | |
|---|---|---|---|---|---|---|---|---|---|---|
| | | high- | | Vertical streaks in | | | | | Fixing | |
| | | temperature | | low-temperature | Image density in | | | | temperature in | |
| | | high-humidity | | low-humidity | high-temperature | | | | normal· | |
| | | environment | | environment | high-humidity environment | | | | temperature | |
| | | 1st | | 1,000th | 1st | | 15.000th | | ormal-humidity | |
| | Toner | sheet | | sheet | sheet | | sheet | | environment | |
| Example 1 | Toner 1 | A | 0.3 | A | A | 1.46 | A | 1.45 | A | 146 |
| Example 2 | Toner 2 | A | 0.2 | C | A | 1.47 | A | 1.46 | A | 146 |
| Example 3 | Toner 3 | C | 2.3 | B | A | 1.42 | B | 1.37 | A | 146 |
| Example 4 | Toner 4 | B | 1.3 | A | B | 1.38 | B | 1.3 | A | 146 |
| Example 5 | Toner 5 | C | 1.9 | A | B | 1.34 | C | 1.23 | A | 146 |
| Example 6 | Toner 6 | A | 0.3 | A | A | 1.46 | A | 1.45 | B | 158 |
| Example 7 | Toner 7 | A | 0.3 | A | A | 1.46 | A | 1.45 | C | 166 |
| Example 8 | Toner 8 | A | 0.4 | A | A | 1.46 | B | 1.39 | A | 146 |
| Example 9 | Toner 9 | B | 0.6 | A | A | 1.46 | B | 1.33 | A | 146 |
| Example 10 | Toner 10 | A | 0.3 | A | A | 1.46 | B | 1.36 | B | 156 |
| Example 11 | Toner 11 | A | 0.3 | A | A | 1.45 | C | 1.29 | C | 164 |
| Example 12 | Toner 12 | B | 1.3 | B | A | 1.42 | B | 1.33 | A | 146 |
| Example 13 | Toner 13 | C | 1.6 | C | A | 1.41 | B | 1.3 | A | 144 |
| Example 14 | Toner 14 | A | 0.3 | A | A | 146 | A | 146 | B | 158 |
| Example 15 | Toner 15 | A | 0.2 | A | A | 146 | A | 146 | C | 164 |
| Example 16 | Toner 16 | A | 0.4 | A | A | 1.43 | A | 1.41 | A | 146 |
| Example 17 | Toner 17 | A | 0.4 | A | A | 1.43 | A | 1.4 | A | 146 |
| Example 18 | Toner 18 | A | 0.3 | B | A | 1.44 | B | 1.37 | A | 146 |
| Example 19 | Toner 19 | A | 0.3 | A | A | 1.46 | B | 1.38 | A | 146 |
| Example 20 | Toner 20 | A | 0.3 | A | A | 1.46 | B | 1.32 | A | 146 |
| Example 21 | Toner 21 | A | 0.2 | B | A | 1.47 | A | 1.46 | A | 146 |
| Example 22 | Toner 22 | B | 1.4 | A | A | 1.43 | B | 1.39 | A | 146 |
| Example 23 | Toner 23 | B | 0.7 | A | A | 1.4 | B | 1.35 | A | 146 |
| Example 24 | Toner 24 | A | 0.3 | A | A | 1.46 | A | 1.4 | A | 148 |
| Comparative | Comparative | C | 2.3 | D | A | 1.42 | D | 1.19 | A | 148 |
| Example 1 | Toner 1 | | | | | | | | | |
| Comparative | Comparative | D | 2.9 | B | A | 1.4 | D | 1.17 | A | 146 |
| Example 2 | Toner 2 | | | | | | | | | |
| Comparative | Comparative | B | 1.4 | A | A | 1.43 | D | 1.12 | B | 152 |
| Example 3 | Toner 3 | | | | | | | | | |
| Comparative | Comparative | A | 0.2 | D | A | 1.47 | A | 1.46 | A | 146 |
| Example 4 | Toner 4 | | | | | | | | | |

### Examples 2 to 24, Comparative Examples 1 to 3

These were evaluated in the same way as the Example 1, with the results shown in Table 5.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-045835, filed Mar. 16, 2020, which is hereby incorporated by reference herein in its entirety.

What is claimed is:

1. A toner comprising a toner particle and an external additive on a surface of the toner particle, wherein
the toner particle comprises
a core particle containing a binder resin and
a shell layer on a surface of the core particle,
the shell layer comprises a compound containing nitrogen atoms,
the external additive comprises an organosilicon polymer particle, and
a difference between the work function Wa of the organosilicon polymer particle and the work function Wb of the toner particle satisfies the following formula (A):
0.00 eV<Wa−Wb≤0.75 eV (A)

2. The toner according to claim 1, wherein a coverage of the core particle by the shell layer in transmission electron microscope observation is at least 30%.

3. The toner according to claim 1, wherein the shell layer has an average value of a thickness of 1 to 250 nm.

4. The toner according to claim 1, wherein the organosilicon polymer particle has primary particles having a number average particle diameter of 30 nm to 500 nm.

5. The toner according to claim 1, wherein a content of the organosilicon polymer particle in the toner is from 0.10 mass % to 8.00 mass %.

6. The toner according to claim 1, wherein a coverage of the shell layer by the organosilicon polymer particle in transmission electron microscope observation is at least 10%.

7. The toner according to claim 1, wherein the shell layer has at least one selected from the group consisting of melamine resins, urea resins and resins having oxazoline groups.

8. The toner according to claim 1, wherein the organosilicon polymer particle has a structure of alternately bonded silicon atoms and oxygen atoms,
the organosilicon polymer particle has a T3 unit structure represented by formula (1) below:
R¹—SiO_{3/2} (1)
in which R¹ represents a C₁₋₆ alkyl group or phenyl group, and
in ²⁹S1-NMR measurement of the organosilicon polymer particle, a ratio of a peak area derived from silicon having a T3 unit structure with respect to a total area of peaks derived from all silicon element contained in the organosilicon polymer particle is from 0.50 to 1.00.

9. The toner according to claim 1, wherein a fixing index of the organosilicon polymer particle on a polycarbonate film as calculated by formula (I) below is not more than 4.5:
Fixing index=Area ratio A of organosilicon polymer particles moving to polycarbonate film/coverage B of organosilicon polymer particles on toner particle surface×100 (1)

10. The toner according to claim 1, wherein a dispersity evaluation index of the organosilicon polymer particle on a toner surface is from 0.5 to 2.0.
